(19) United States
(12) Patent Application Publication
(10) Pub. No.: US 2015/0345972 A1
(43) Pub. Date: Dec. 3, 2015

(54) VEHICLE INFORMATION PROVIDING DEVICE

(71) Applicant: NISSAN MOTOR CO., LTD., Yokohama-shi, Kanagawa (JP)

(72) Inventors: Daisuke SAITO, Ebina-shi, Kanagawa (JP); Hirofumi INOUE, Yamato-shi, Kanagawa (JP); Toshiro MURAMATSU, Zushi-shi, Kanagawa (JP)

(73) Assignee: NISSAN MOTOR CO., LTD., Yokohama-shi, Kanagawa (JP)

(21) Appl. No.: 14/653,593

(22) PCT Filed: May 31, 2013
(86) PCT No.: PCT/JP2013/065166

§ 371 Date: Jun. 18, 2015

(30) Foreign Application Priority Data
Dec. 27, 2012 (JP) 2012-284274

(51) Int. Cl. G01C 21/36

(52) U.S. Cl. CPC G01C 21/36

(57) ABSTRACT

A vehicle information providing device provides route information to vehicles. The vehicle information providing device has a history information accumulation unit that sequentially acquires at least one of driving location information, power consumption information and charging location information from vehicle-mounted devices of a plurality of vehicle, and accumulates this as driving history information. A composite route generation unit generates a composite route by combining a plurality of routes traveled by the same vehicle or by a plurality of vehicles. A presentation information provision unit provides information regarding the composite routes that are generated by the composite route generation unit. The composite route generation unit extracts information regarding the travel start and end points of the routes included in the driving history information when generating the composite route and combines the routes for which the travel end points and the travel start points are within a predetermined spatial range.

This application is a U.S. National stage application of International Application No. PCT/JP2013/065166, filed May 31, 2013, which claims priority to Japanese Patent Application No. 2012-284274 filed in Japan on Dec. 27, 2012. The entire disclosure of the Japanese Patent Application No. 2012-284274 is hereby incorporated herein by reference.

### BACKGROUND

1. Field of the Invention

The present invention relates to an information providing device for a vehicle that provides information, such as power consumption and charging hub information, when driving a vehicle with an electric motor as a drive source to a destination.

2. Background Information

Conventionally, a technology is known in which, in a vehicle with an electric motor as a drive source, a route to the destination is searched for, and the power to be consumed when driving a route based on the power consumption for the entire length of the searched route, as well as per a predetermined unit of distance (hereinafter, also referred to as the theoretical performance of the vehicle), is predicted (refer to, for example, Japanese Laid-Open Patent Application No. 2011-38845). In the technology of Japanese Laid-Open Patent Application No. 2011-38845, when the predicted power consumption is greater than the charged amount of the battery for running the vehicle, the route, as well as information regarding the charging points, which are points at which the battery for running the vehicle can be charged, is provided.

### SUMMARY

Since the conventional technology described above predicts power consumption based on the theoretical performance of the vehicle, subsequently, there were cases in which the above-described conventional technology could not appropriately provide the necessary information to the driver. In view of the point described above, an object of the present invention is to provide information regarding the power consumption and information regarding the charging hubs that are in accordance with the actual environment.

In order to achieve the above-described object, in the present invention, at least the driving location information, the power consumption information, or the charging position information is sequentially acquired from a vehicle-mounted device mounted in a vehicle with an electric motor as the drive source, and this information is accumulated as the driving history information; referring to the accumulated driving history information and the information regarding the travel start point and the travel end point of each route, which is included in the driving history information, a composite route is generated by combining the routes whose travel end points and travel start points are within predetermined spatial ranges, and information regarding this composite route is thus provided.

According to the present invention, with reference to the driving history information, that is, the information that is acquired while the vehicle actually travels, the routes with travel end points and travel start points that are within a predetermined spatial range are combined to generate a composite route, and information regarding this composite route is provided; as a result, appropriately providing information regarding the driving history that is in line with the actual environment is possible.

### BRIEF DESCRIPTION OF THE DRAWINGS

Referring now to the attached drawings which form a part of this original disclosure.

FIG. 1 is a view illustrating a schematic overview of a vehicle information provision system.

FIG. 2 is a view illustrating one example of the contents displayed by a display unit.

FIG. 3 is a flowchart representing the driving history information recording operation.

FIG. 4 is a flowchart representing the route provision operation.

FIG. 5 is a flowchart representing the history accumulation operation.

FIG. 6 is a flowchart representing the driving history statistical processing step.

FIG. 7 is a view showing a method for searching for similar routes.

FIG. 8 is an explanatory view representing a composite route.

FIG. 9 is a view showing one example of a method for generating a composite route.

FIG. 10 is a view showing one example of a method for generating a composite route.

FIG. 11 is a view showing another example of a method for generating a composite route.

FIG. 12 is a flowchart representing the charging hub extraction operation.

FIG. 13 is a flowchart representing the power consumption correction operation.

FIG. 14 is a view showing one example of a method for generating a composite route.

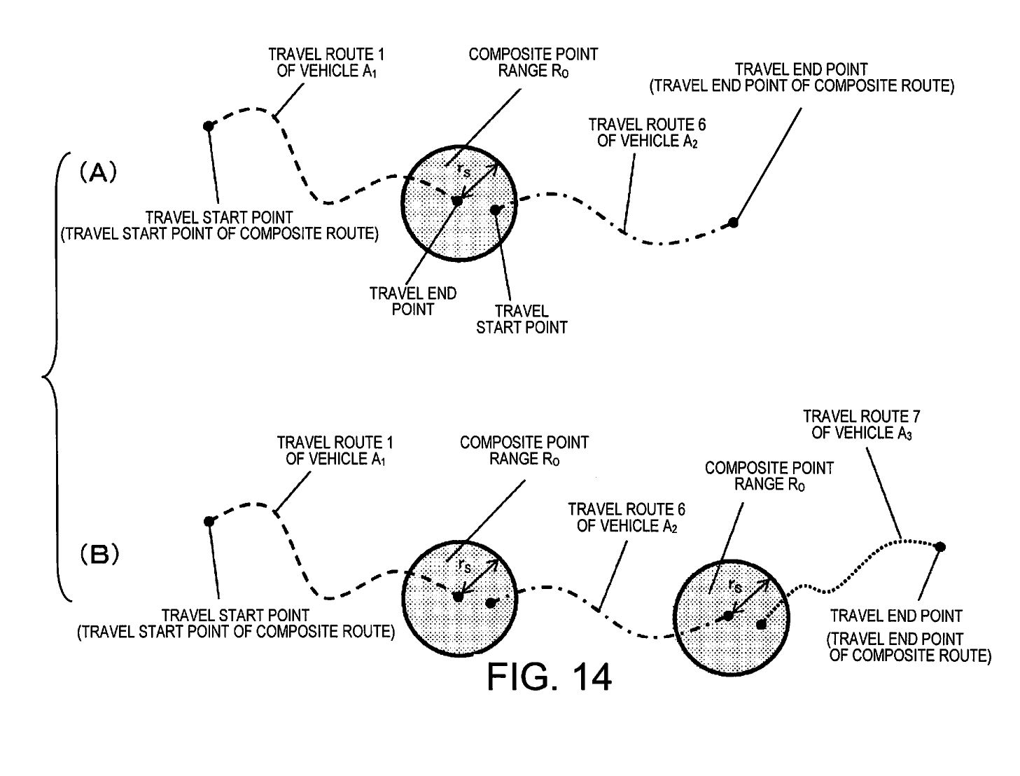

FIG. 15 is a view illustrating another example of the contents displayed by a display unit.

FIG. 16 is a view illustrating another example of the contents displayed by a display unit.

### DETAILED DESCRIPTION OF THE EMBODIMENTS

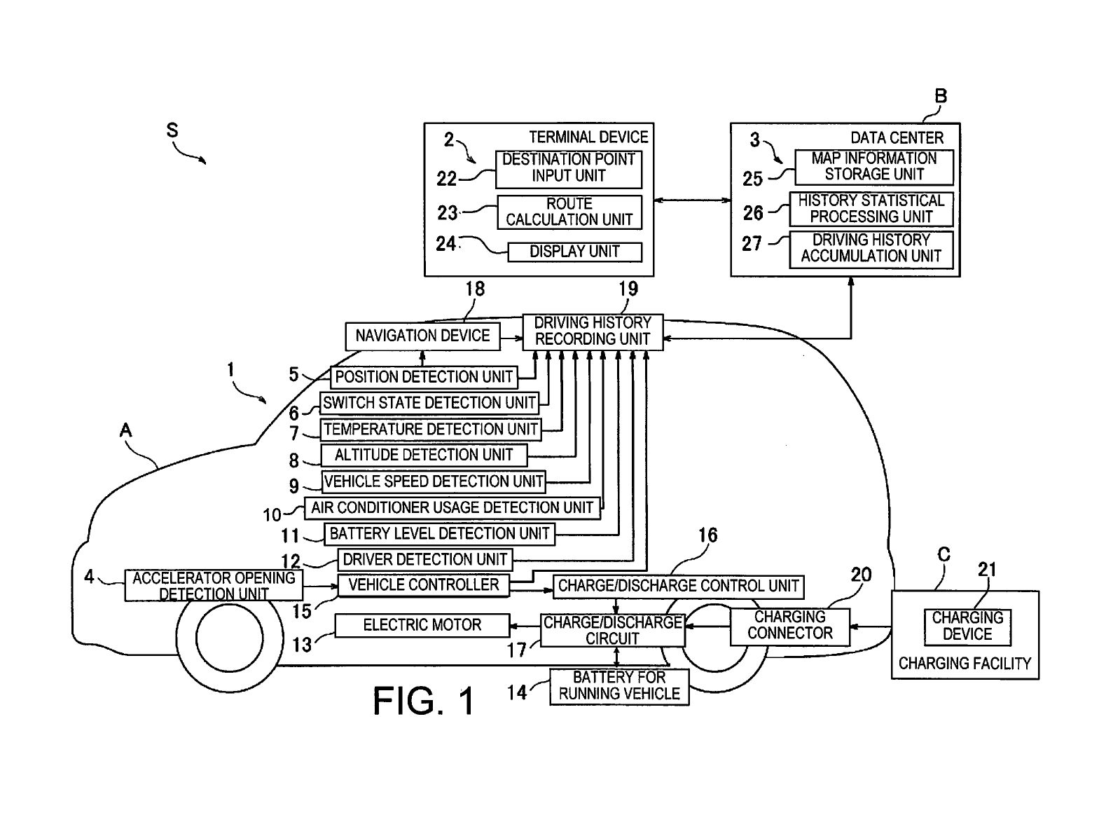

FIG. 1 is a view illustrating a schematic overview of a vehicle information provision system S according to the present embodiment. As illustrated in FIG. 1, the vehicle information provision system S of the present embodiment comprises a vehicle-mounted device 1 that is mounted to a plurality of vehicles A that have an electric motor 13 as a drive source, a terminal device 2 possessed by the owner of the vehicle A, and an vehicle information providing device 3 present in a data center B. The vehicle-mounted device 1 and the vehicle information providing device 3, as well as the terminal device 2 and the vehicle information providing device 3, send and receive various types of information via a communication path. Examples of communication paths include a cellular telephone network, a wireless LAN network, a DSRC (Dedicated Short-Range Communications) network, and a power line communication network, etc. For example, the configuration can be such that both the vehicle-mounted device 1 and the vehicle information providing device 3 store various types of information in a removable storage medium, such as a flash memory, and they send and receive the various types of stored information via a terminal having a communication function.

The vehicle-mounted device 1 comprises an accelerator opening detection unit 4, a position detection unit 5, a switch state detection unit 6, a temperature detection unit 7, an altitude detection unit 8, a vehicle speed detection unit 9, an air conditioner usage detection unit 10, a battery level detection unit 11, and a driver detection unit 12.

The accelerator opening detection unit 4 detects the accelerator opening of a host vehicle A. Then, the accelerator opening detection unit 4 outputs the information regarding the detection results to a vehicle controller 15 described below. The position detection unit 5 detects the current position of the host vehicle A (for example, the latitude and longitude) based on a GPS signal transmitted by a GPS (Global Positioning System) satellite. Then, the position detection unit 5 will output the information regarding the detection results to a navigation device 18 described below.

The switch state detection unit 6 detects the switch state of an ignition switch on the host vehicle A. The switch states of the ignition switch may be, for example, an ON state and an OFF state. The switch state detection unit 6 outputs the information regarding the detection results to a driving history recording unit 19 described below. The temperature detection unit 7 detects the temperature of the current position of the host vehicle A. The temperature detection unit 7 outputs the information regarding the detection results to the driving history recording unit 19 described below.

The altitude detection unit 8 detects the altitude of the current position of the host vehicle A. Then, the altitude detection unit 8 outputs the information regarding the detection results to the driving history recording unit 19 described below. The vehicle speed detection unit 9 detects the vehicle speed of the host vehicle A. Then, the vehicle speed detection unit 9 outputs the information regarding the detection results to the driving history recording unit 19 described below. The air conditioner usage detection unit 10 detects the air conditioner usage of the host vehicle A. The air conditioner usage is, for example, the power that is consumed by the air conditioner. The air conditioner usage detection unit 10 outputs the information regarding the detection results to the driving history recording unit 19 described below.

The battery level detection unit 11 detects the battery level of the vehicle A. In the present embodiment, the battery level can be the remaining charge of the battery 14 for running the vehicle for supplying electric power to the electric motor 13, which is the drive source. Then, the battery level detection unit 11 outputs the information regarding the detection results to the driving history recording unit 19 described below. The driver detection unit 12 detects the driver ID (Identification) of the driver of the host vehicle A. A driver ID can be, for example, a number, etc. for uniquely identifying the driver. Then, the driver detection unit 12 outputs the information regarding the detection results to the driving history recording unit 19 described below.

The vehicle-mounted device 1 also comprises a vehicle controller 15, a charge/discharge controller 16, a charge/discharge circuit 17, a navigation device 18, and a driving history recording unit 19.

The vehicle controller 15 acquires the information (accelerator opening) output by the accelerator opening detection unit 4. Then, the vehicle controller 15 outputs the acquired information to the driving history recording unit 19. The vehicle controller 15 outputs a control command to the charge/discharge controller 16 to supply electric power that corresponds to the accelerator opening of the electric motor 13.

Following the control command from the vehicle controller 15, the charge/discharge controller 16 outputs a control command to the charge/discharge circuit 17 to supply the electric power that is stored by the battery 14 for running the vehicle to the electric motor 13. Additionally, the charge/discharge controller 16 detects the charging state and the charging time of the battery 14 for running the vehicle. Charging states may be, for example, the distinction between currently charging and not currently charging. The charging time may be, for example, the time from starting charging to finishing charging. Then, the charge/discharge controller 16 outputs the information regarding the detection results to the travel history storage unit 19.

The charge/discharge circuit 17 supplies the electric power stored by the battery 14 for running the vehicle to the electric motor 13, following the control command from the charge/discharge controller 16. The electric motor 13 thereby generates a drive force. The charge/discharge circuit 17 connects with a charging device 21 via a charging connector 20. This type of charging device 21 may be, for example, a device for supplying electric power for charging the battery 14 for running the vehicle, which is provided in a charging facility C that is provided outside of the vehicle A. Then, electric power from the charging device 21 is supplied to the charge/discharge circuit 17 with the charging connector 20 being connected to the charging device 21, and the battery 14 for running the vehicle is thereby charged.

The navigation device 18 acquires the information (the latitude and longitude (the current position of the vehicle A)) that is output by the position detection unit 5. Then, the navigation device 18 presents information to the driver for guiding the vehicle A along a route from an departure point P_{O} to a destination point P_{D}, which are set by the driver, based on the acquired information (the latitude and longitude (the current position of the vehicle A)). Additionally, the navigation device 18 outputs the acquired information and the route to the driving history recording unit 19.

The driving history recording unit 19 executes a driving history information recording operation, based on the information output from the various detection units 6-12, the vehicle controller 15, the charge/discharge controller 16, and the navigation device 18.

In the driving history information recording operation, a first piece of driving history information and a second piece of driving history information described below are recorded. Then, the driving history recording unit 19 transmits the recorded first piece of driving history information and the second piece of driving history information to the vehicle information providing device 3. The details regarding the first piece of driving history information, the second piece of driving history information, and the driving history information recording operation are described below.

On the other hand, the terminal device 2 comprises a destination point such as the input unit 22, a route calculation unit 23, and a display unit 24. The terminal device 2 may be, for example, a mobile phone terminal, a personal computer, etc. possessed by the owner of the vehicle A.

The destination point such as the input unit 22 receives input regarding the departure point P_{O}, the destination point P_{D}, the battery level (for example, the battery level of the vehicle A that is possessed by the user), and the driver ID (for example, driver ID that identifies the user) from the user of the terminal device 2. Then, the destination point such as the input unit 22 outputs the received information regarding the departure point P_{O}, the destination point P_{D}, the battery level, and the driver ID to the route calculation unit 23.

The route calculation unit 23 executes a route provision operation based on the information output from the destination point such as the input unit 22 and, specifically, information regarding the departure point P_{O} and the destination point P_{D}. In the route provision operation, the route calculation unit 23 transmits the search request for the presentation route (hereinafter also referred to as the presentation route search request) to the vehicle information providing device 3. Next, the route calculation unit 23 receives information regarding the presentation route, the power that is consumed when driving along the presentation route, and the location of charging facilities C (hereinafter also referred to as charging hubs) that will be traversed when driving along the presentation route from the vehicle information providing device 3. The route calculation unit 23, upon receiving the information from the vehicle information providing device 3, outputs a control signal for displaying the received information to the display unit 24. The details of the route provision operation will be described below. In the present embodiment, an example is described in which the terminal device 2 executes the route provision operation, but another configuration may also be used. That is, for example, the configuration may be such that the position detection unit 5, the route calculation unit 23, and the display unit 24 are realized by a navigation device 18 provided to the vehicle A, and executing the route provision operation is executed therewith.

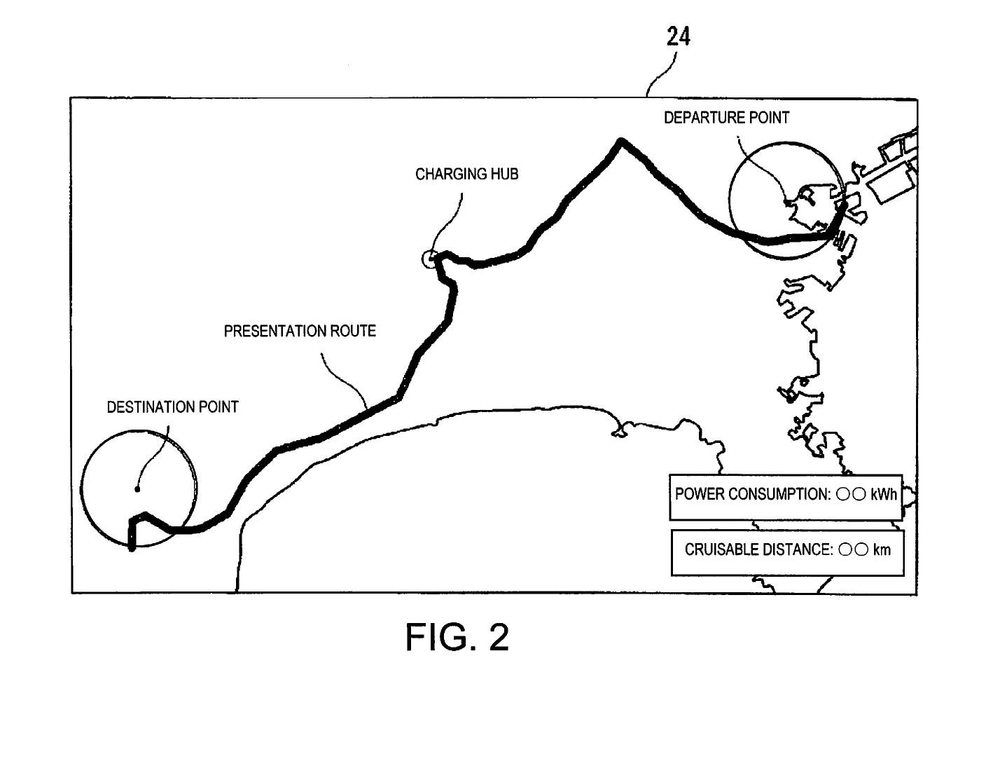

Here, FIG. 2 is a view illustrating one example of the contents displayed by a display unit 24. The display unit 24 displays on the display screen information regarding the presentation route, the power that is consumed when driving along the presentation route, and the charging hubs that will be traversed when driving along the presentation route, following the control command being output by the route calculation unit 23, as illustrated in FIG. 2. The user of the terminal device 2 can thereby confirm beforehand the power consumption and charging hubs when driving the vehicle A to the destination point.

Returning to FIG. 1, the vehicle information providing device 3 comprises a map information storage unit 25, a driving history accumulation unit 26, and a historical statistics processing unit 27.

The map information storage unit 25 stores map information for the region where the vehicle A is traveling. Map information may be, for example, information such as nodes and links that represent a road network, the locations of charging facilities C for charging the battery 14 for running the vehicle, which is provided to the vehicle A, toll roads, and the locations of facilities that are attached to toll roads.

The driving history accumulation unit 26 executes the history information accumulation operation based on the first piece of driving history information and the second piece of driving history information that are transmitted from the vehicle-mounted device 1. Specifically, in the history information accumulation operation, the driving history accumulation unit 26 sequentially receives (acquires) the first piece of driving history information and the second piece of driving history information that are transmitted by the vehicle-mounted device 1. Then, the driving history accumulation unit 26 accumulates the received first piece of driving history information and the second piece of driving history information as the driving history information.

The historical statistics processing unit 27 executes driving history statistical processing by referencing the presentation route search request transmitted from the terminal device 2, the map information stored in the map information storage unit 25, and the driving history information (the first piece of driving history information, the second piece of driving history information) accumulated by the driving history accumulation unit 26.

In the driving history statistical processing step, first, the historical statistics processing unit 27 searches for (acquires) a planned route from a departure point P_{O} to the destination point P_{D} by referencing the map information that is stored by the map information storage unit 25, based on the presentation route search request that is transmitted by the route calculation unit 23. A planned route may be any route that is able to reach a destination point P_{D} from a departure point P_{O} and is not particularly limited; for example, a route that is capable of being traveled from a departure point P_{O} to a destination point P_{D} in the shortest amount of time is set.

Next, in the driving history statistical processing step, the historical statistics processing unit 27 selects the same or a similar presentation route as the searched for (acquired) planned route by referencing the driving history information (the first piece of driving history information) that is accumulated by the driving history accumulation unit 26. This type of method for selecting a presentation route will be described below. Next, the historical statistics processing unit 27 determines the power that actually has been consumed by the vehicle A, as well as the charging hubs that will be traversed when driving along the selected presentation route, by referencing the driving history information (the first piece of driving history information, the second piece of driving history information) that is accumulated by the driving history accumulation unit 26. Then, the historical statistics processing unit 27 transmits (provides) the selected presentation route, the power consumption, and the charging hub information to the vehicle-mounted device 1. The vehicle-mounted device 1 thereby presents the presentation route, the power that is consumed upon traveling along the presentation route, and the charging hubs that will be traversed when driving along the presentation route, based on the information output by the historical statistics processing unit 27. The details of the driving history statistical processing step will be described below.

Travel History Information Recording Operation

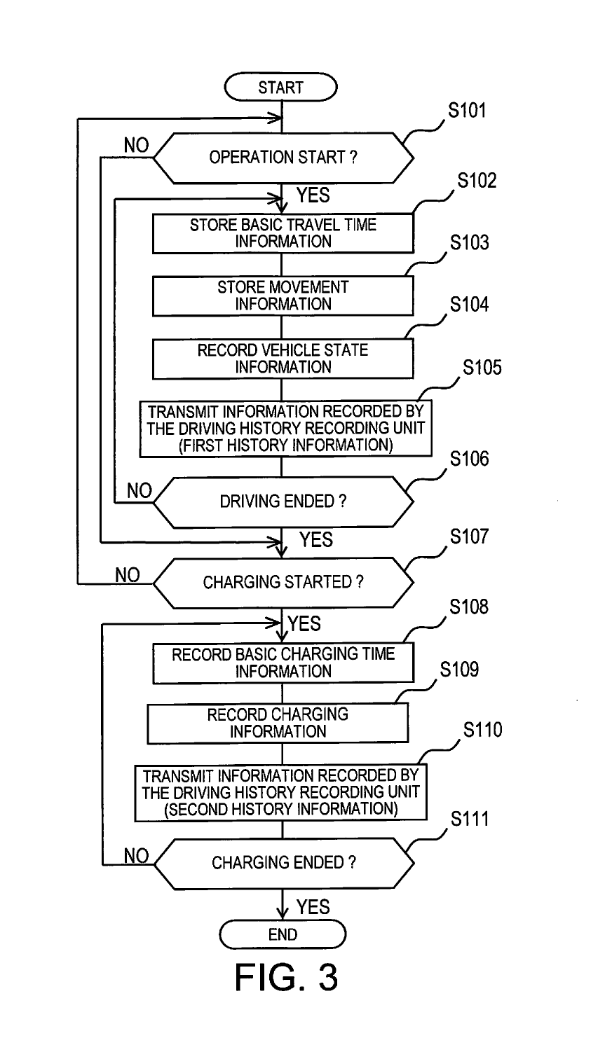

Next, the driving history information recording operation that is executed by the driving history recording unit 19 will be described. The driving history recording unit 19 executes a driving history information recording operation each time a predetermined amount of time (for example, 10 milliseconds) has elapsed. FIG. 3 is a flowchart representing the driving history information recording operation.

In step S101, the driving history recording unit 19 determines whether or not the driver has started driving the vehicle A, as illustrated in FIG. 3. Specifically, the driving history recording unit 19 determines whether or not the ignition switch is in an ON state, based on the information (the switch state of the ignition switch) that is output by the switch state detection unit 6. Then, when a determination is made that the ignition switch is in the ON state (step S101=Yes), the driving history recording unit 19 determines that the driver has started driving the vehicle A, and the operation proceeds to step S102. On the other hand, when a determination is made that the ignition switch is in the OFF state (step S101=No), the driving history recording unit 19 determines that the driver has not started driving the vehicle A, and the operation proceeds to step S107.

When a determination is made that the driver has started driving the vehicle A, the operation proceeds to step S102; in step S102, the driving history recording unit 19 records the vehicle ID information, which specifies the vehicle A; the driver ID information, which is output from the driver detection unit 12; the temperature information, which is output from the temperature detection unit 7; and the current date and time information as the basic travel time information. That is, in the present embodiment, the basic travel time information is information comprising the vehicle ID information, the driver ID information, the temperature information, and the current date and time information.

Next, the operation proceeds to step S103, and the driving history recording unit 19 records the latitude and longitude information, as well as the altitude information that are output from the position detection unit 5 and the altitude detection unit 8, along with the route information (hereinafter also referred to as the driving location information) as the movement information. That is, in the present embodiment, the movement information includes the latitude and longitude information, the altitude information, and the route information (the driving location information). For example, since the vehicle A can be considered to be traveling along a route that is presented by the navigation device 18, information that is output by the navigation device 18 (route) can be used as the route.

The operation then proceeds to step S104, and the driving history recording unit 19 records the vehicle speed information, the accelerator opening information, and the air conditioner usage information output from each of the detection units 4, 8, 9, 10 as the vehicle state information. When traveling along the route that is provided by the navigation device 18 has been completed, the driving history recording unit 19 includes information regarding the power that was consumed upon traveling the route (hereinafter also referred to as the power consumption information) in the vehicle state information that is to be recorded. That is, in the present embodiment, the vehicle state information is included the vehicle speed information, the accelerator opening information, the air conditioner usage information, and the information regarding power consumption (the power consumption information). As an example of a calculation method, the power consumption can be determined by subtracting the battery level at the time of reaching the destination point P_{D} from the battery level at the time of departing from the departure point P_{O} of the route.

The operation then proceeds to step S105, and the driving history recording unit 19 transmits information comprising the basic travel time information, the movement information, and the vehicle state information recorded by the driving history recording unit 19 to the vehicle information providing device 3 as the first piece of driving history information.

The operation then proceeds to step S106, and the driving history recording unit 19 determines whether or not the driver has finished driving the vehicle A. Specifically, the driving history recording unit 19 determines whether or not the ignition switch is in an OFF state, based on the information regarding the switch state of the ignition switch that is output by the switch state detection unit 6. Then, when a determination is made that the ignition switch is in the OFF state (step S106=Yes), the driving history recording unit 19 determines that the driver has finished driving the vehicle A, and the operation proceeds to step S107. On the other hand, when a determination is made that the ignition switch is in the ON state (step S106=No), the driving history recording unit 19 determines that the driver has not finished driving the vehicle A, the operation returns step S102, and the operations of steps S102-S106 are repeatedly executed until a determination is made that the driver has finished driving the vehicle A.

When a determination is made that the driver has finished driving the vehicle A, the operation proceeds to step S107; in step S107, the driving history recording unit 19 determines whether or not charging the battery 14 for running the vehicle has started. Specifically, the driving history recording unit 19 determines whether or not the battery 14 for running the vehicle is in a charging state based on the charging state information for the battery 14 for running the vehicle that is output from the charge/discharge controller 16. Then, when a determination is made that the battery 14 for running the vehicle is in a charging state (step S107=Yes), the driving history recording unit 19 determines that the battery 14 has started charging, and the operation proceeds to step S108. On the other hand, when a determination is made that the battery 14 for running the vehicle is not in a charging state (step S107=No), the driving history recording unit 19 determines that the battery 14 for running the vehicle has not started charging, the operation returns to step S101, and the operations of steps S101 and S107 are repeatedly executed until the driving of the vehicle A has started (step S101=Yes) or the the battery 14 for running the vehicle has started charging (step S107=Yes).

When the battery 14 for running the vehicle has started charging, the operation proceeds to step S108; in step S108, the driving history recording unit 19 records the temperature information output from the temperature detection unit 7, as well as the current date and time information, as the basic charge time information. That is, in the present embodiment, the basic charge time information includes the temperature information and the current date and time information.

Next, the operation proceeds to step S109, and the driving history recording unit 19 stores the latitude and longitude information output from the position detection unit 5, the battery level detection unit 11, the charge/discharge controller 16 (hereinafter also referred to as the charging hub information, the charging position information), the charging amount information, and the charging time information as the charging information. That is, in the present embodiment, the charging information includes the latitude and longitude information (the charging hub information, the charging position information), the charging amount information, and the charging time information.

The operation then proceeds to step S110, and the driving history recording unit 19 transmits information comprising the basic charge time information and the charging information recorded by the driving history recording unit 19 to the vehicle information providing device 3 as the second piece of driving history information. At this time, the driving history recording unit 19 transmits the second piece of driving history information to the vehicle information providing device 3, along with the first piece of driving history information that was transmitted in step S105 described above. The route that the vehicle A traveled thereby correlates with the charging hubs that were traversed when driving along the route.

The operation then proceeds to step S111, and the driving history recording unit 19 determines whether or not the battery 14 for running the vehicle has finished charging. Specifically, the driving history recording unit 19 determines whether or not the battery 14 for running the vehicle is in a charging state based on the charging state information of the battery 14 for running the vehicle that is output from the charge/discharge controller 16. Then, when a determination is made that the battery 14 for running the vehicle is not in a charging state (step S111=Yes), the driving history recording unit 19 determines that the battery 14 for running the vehicle has finished charging, and the driving history information recording operation ends. On the other hand, when a determination is made that the battery 14 for running the vehicle is in a charging state (step S111=No), the driving history recording unit 19 determines that the battery 14 for running the vehicle has not finished charging, the operation returns to step S108, and the operations of steps S108-S111 are repeatedly executed until a determination is made that the battery 14 for running the vehicle has finished charging.

Route Provision Operation

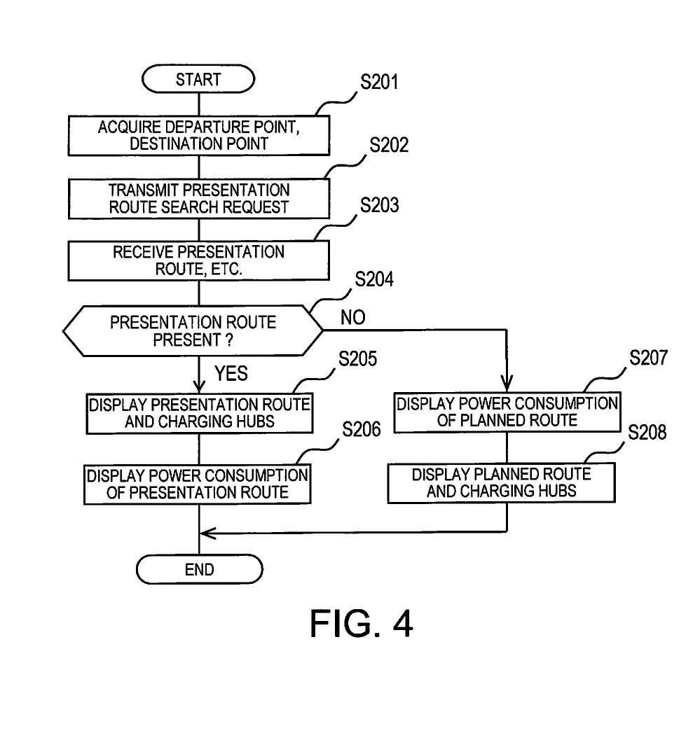

Next, the route provision operation that is executed by the route calculation unit 23 will be described. The route calculation unit 23 executes a route provision operation described below when information regarding the departure point P_{O}, the destination point P_{D}, the battery level, and the driver ID are input from the destination point such as the input unit 22. FIG. 4 is a flowchart representing the route provision operation.

First, in step S201, the route calculation unit 23 acquires information regarding the departure point P_{O}, the destination point P_{D}, the battery level, and the driver ID output from the destination point such as the input unit 22, as illustrated in FIG. 4

The operation then proceeds to step S202, and the route calculation unit 23 transmits a presentation route search request to the vehicle information providing device 3. Specifically, the route calculation unit 23 transmits the presentation route search request, along with information regarding the departure point P_{O}, the destination point P_{D}, the battery level, and the driver ID acquired in step S201 described above, to the vehicle information providing device 3.

Then, in response to the presentation route search request that is output from the route calculation unit 23, the historical statistics processing unit 27 of the vehicle information providing device 3 searches for (acquires) the planned route from the departure point P_{O} to the destination point P_{D} by referencing the map information that is stored in the map information storage unit 25. Next, the historical statistics processing unit 27 searches for a route that is identical or similar to the planned route (hereinafter referred to as the similar route) by referencing the first piece of driving history information that is accumulated by the driving history accumulation unit 26 and selects the searched similar route to be the presentation route. The method for selecting a presentation route will be described below. The historical statistics processing unit 27 then determines the power that has been consumed when driving the selected presentation route, as well as the charging hubs that will be traversed when driving along the presentation route, by referencing the first piece of driving history information and the second piece of driving history information, which are accumulated by the driving history accumulation unit 26. The method for determining the power consumption and the charging hubs will be described below. Then, the historical statistics processing unit 27 transmits (provides) the selected presentation route, the power consumption, and the charging hub information to terminal device 2. For example, when a presentation route cannot be selected (calculated), such as when a corresponding similar route does not exist, the historical statistics processing unit 27 transmits (provides) information regarding the searched planned route, instead of the presentation route information, to the terminal device 2.

The operation then proceeds to step S203, and the route calculation unit 23 receives information including the presentation route information, the power consumption information, and the charging hub information, which are transmitted by the vehicle information providing device 3. If a presentation route could not be selected in step S202, the route calculation unit 23 receives the planned route information instead of the presentation route information.

The operation then proceeds to step S204, and the route calculation unit 23 determines whether or not the presentation route information was received in step S203. If the route calculation unit 23 determines that the presentation route information has been received (step S204=Yes), the operation proceeds to step S205. On the other hand, if the route calculation unit 23 determines that the planned route information has been received instead of the presentation route information (step S204=No), the operation proceeds to step S207.

If a determination is made that the presentation route information has been received, the operation proceeds to step S205; in step S205, the route calculation unit 23 outputs a control command to the display unit 24 to display the presentation route information and the charging hub information from the information acquired in the above-described step S203 (the presentation route information, the power consumption information, and the charging hub information).

Next, in step S206, the route calculation unit 23 outputs a control command to the display unit 24 to display the power consumption information from the information acquired in the above-described step S203 (the presentation route information, the power consumption information, and the charging hub information), after which the route provision operation ends. A display such as that illustrated in FIG. 2 is thereby displayed on the display screen.

On the other hand, if a determination is made that the presentation route information has not been received, the operation proceeds to step S207; in step S207, the route calculation unit 23 outputs a control command to the display unit 24 to display the planned route information and the charging hub information from the information acquired in the above-described step S203 (the planned route information, the power consumption information, and the charging hub information).

Next, in step S208, the route calculation unit 23 outputs a control command to the display unit 24 to display the power consumption information from the information acquired in the above-described step S203 (the planned route information, the power consumption information, and the charging hub information), after which the route provision operation ends. A display such as that illustrated in FIG. 2 is thereby displayed on the display screen.

History Accumulation Operation

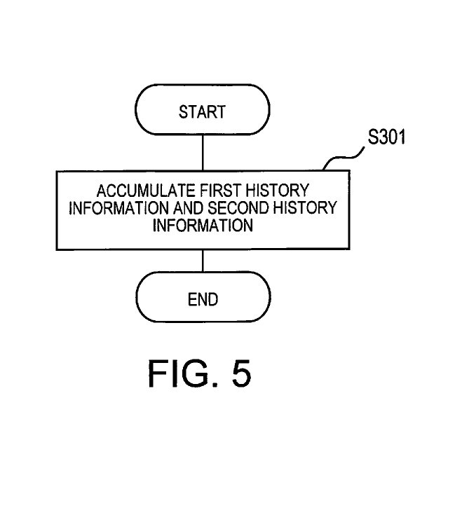

Next, the history accumulation operation that is executed by the driving history accumulation unit 26 will be described. The driving history accumulation unit 26 executes the history accumulation operation when receiving the first piece of driving history information or the second piece of driving history information from the route calculation unit 23. FIG. 5 is a flowchart representing the history accumulation operation.

In step S301, the driving history accumulation unit 26 accumulates the received first piece of driving history information or the second piece of driving history information as the driving history information, and the history accumulation operation ends, as illustrated in FIG. 5. At this time, the driving history accumulation unit 26 includes information regarding the presence/absence of traffic jams, the day of the week, the season, the weather, the travel time zone, the air conditioner power consumption, the travel power consumption, and the average speed in the driving history information (the first piece of driving history information, the second piece of driving history information) to be accumulated. For example, the presence/absence of traffic jams on the traveling date/time and along the route, which are included in the first piece of driving history information, can be detected, and the detected information can be used as the information regarding the presence/absence of traffic jams. Information regarding the day of the week may be, for example, the day of the week associated with the traveling date/time, which is included in the first piece of driving history information. Information regarding the season may be, for example, the season associated with the traveling date/time, which is included in the first piece of driving history information. Additionally, the weather on the traveling date/time and at the specified latitude and longitude, which are included in the first piece of driving history information, can be detected, and the detected information can be used as the information regarding the weather. Information regarding the time zone may be, for example, the time zone associated with the traveling date/time, which is included in the first piece of driving history information. Examples of information regarding the air conditioner power consumption include the ON/OFF information of the air conditioner included in the first piece of driving history information and information regarding the power consumption of the air conditioner per unit of time. Information regarding the travel power consumption may be, for example, the amount of decrease in the battery level per unit of time while traveling, which is included in the first piece of driving history information. Information regarding the average speed may be, for example, the average value of the vehicle speed over a set period of time (for example, 10 minutes), which is included in the first piece of driving history information.

In the present embodiment, an example was described in which the driving history recording unit 19 uses the route information that is output from the navigation device 18 as the route, but another configuration may also be employed. For example, if the route in the first piece of driving history information includes a portion for which the vehicle A traveled a different route, the driving history accumulation unit 26 corrects the above to the route that the vehicle A actually traveled, based on the driving history information (the latitude and longitude), which is accumulated by the driving history accumulation unit 26. The driving history accumulation unit 26 thereby accumulates information regarding the route that the vehicle A actually traveled. A latitude and longitude sequence or a road link string after a common dead reckoning or a latitude and longitude sequence or a road link string after map matching may be employed as the information regarding the actual traveled route. Dead reckoning is location information that is obtained by, for example, correcting GPS latitude and longitude information detected by the position detection unit 5 with respect to the speed information provided by the vehicle speed detection unit 9. A method for increasing the correction accuracy by taking into consideration the gyro-sensor (acceleration sensor) information, which is not diagrammed, is also known. Map matching is known as a method for detecting the most likely location on the road by detecting whether or not one is traveling on a road by looking at both the GPS latitude and longitude information that is detected by the position detection unit 5 or the latitude and longitude after the above-described dead reckoning, as well as the road link, the node information, and, during navigation, the route information, which are possessed by the navigation device 18, and if on a road, a determination regarding the roads have been passed.

Driving History Statistical Processing

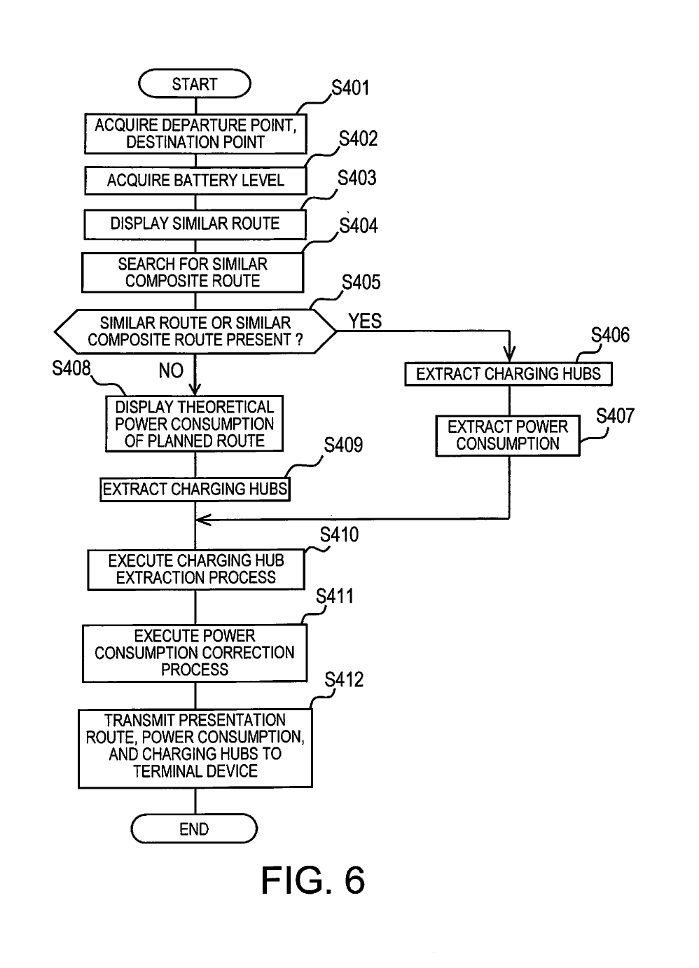

Next, the driving history statistical processing step that is executed by the historical statistics processing unit 27 will be described. The historical statistics processing unit 27 executes the history statistical processing step when receiving the presentation route search request that is transmitted by the terminal device 2. FIG. 6 is a flowchart representing the driving history statistical processing step.

First, in step S401, the historical statistics processing unit 27 acquires the departure point P_{O} and the destination point P_{D} from the received presentation route search request, as illustrated in FIG. 6. Next, the historical statistics processing unit 27 searches for (acquires) the planned route from the acquired departure point P_{O} to the destination point P_{D}, based on the map information that is stored by the map information storage unit 25. A planned route may be any route that is able to reach a destination point P_{D} from a departure point P_{O} and is not particularly limited; for example, a route that is capable of leaving a departure point P_{O} and reaching a destination point P_{D} in the shortest amount of time is set.

In the present embodiment, an example was described in which the historical statistics processing unit 27 that is provided to the vehicle information providing device 3 searches for (acquires) a planned route, but another configuration may also be used. For example, the configuration may be such that a navigation device 18 provided to the vehicle-mounted device 1 searches for the planned route. In this case, the navigation device 18 transmits the search result of the planned route to the historical statistics processing unit 27, and the historical statistics processing unit 27 transmits (acquires) the planned route transmitted from the navigation device 18.

The operation then proceeds to step S402, and the historical statistics processing unit 27 acquires the battery level information from the received presentation route search request. The method for acquiring the battery level information may be a method for making an inquiry to the battery level detection unit 11 of the vehicle A from the terminal device 2 via the data center B or a method in which the user inputs an arbitrary battery level. According to the former method, the calculation can be made based on the most recent battery level when actually departing; as a result, obtaining a result that is in line with the ordinary state at the current time is possible. According to the latter method, the user can specify the battery level beforehand, which makes obtaining a result assuming a departure after the battery has been charged 100% possible.

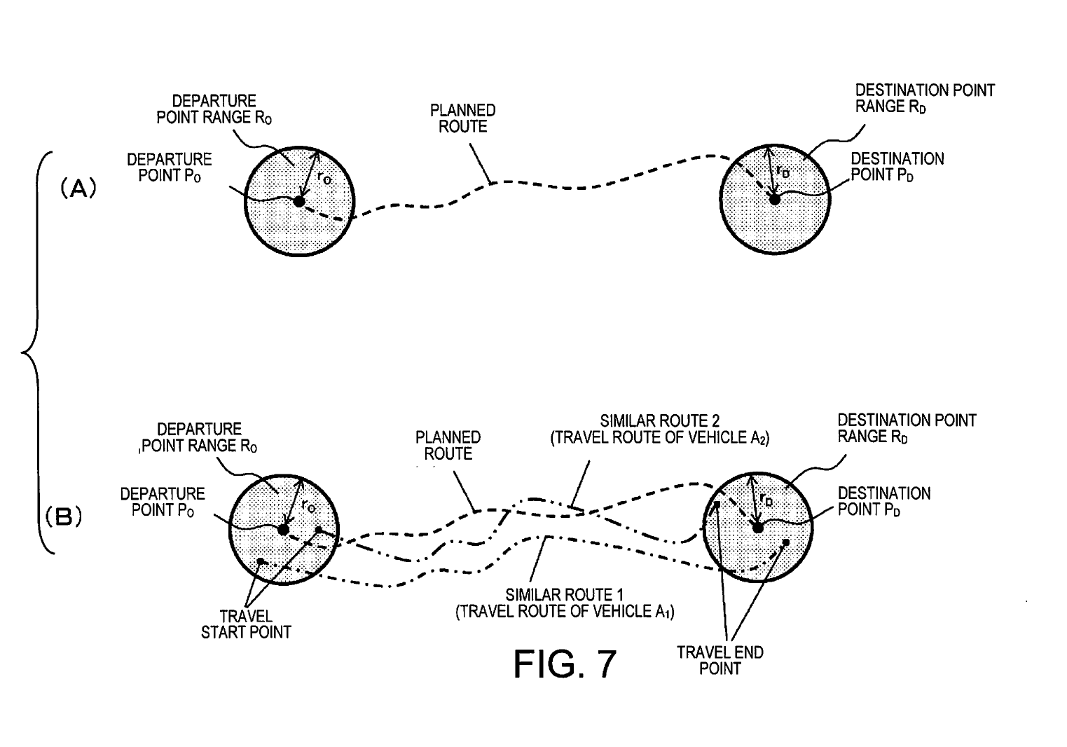

Next, the operation proceeds to step S403; in step S403, the historical statistics processing unit 27 executes a search for a similar route. Specifically, the historical statistics processing unit 27 sets the departure point range R_{O} and the destination point range R_{D} based on the departure point P_{O} and the destination point P_{D} included in the received presentation route search request. FIG. 7 is a view showing a method for searching for similar routes of the present embodiment. In the present embodiment, the historical statistics processing unit 27 sets a circular range having a radius r_{O} from the departure point P_{O} as the departure point range R_{O} and sets a circular range having a radius r_{D} from the destination point as the destination point range R_{D}, as illustrated in part (A) of FIG. 7.

Next, from the first piece of driving history information (route) accumulated by the driving history accumulation unit 26, the historical statistics processing unit 27 searches for a route having a travel start point and a travel end point within the set departure point range R_{O} and the destination point range R_{D} and detects the searched route to be a similar route. Specifically, the historical statistics processing unit 27 sets a route in which the travel start point is within the departure point range R_{O} and the travel end point is within the destination point range R_{D} as a similar route. For example, in the example illustrated in FIG. 7(B), an example is shown in which two routes, “similar route 1” and “similar route 2,” are detected in relation to the planned route that connects the departure point P_{O} and the destination point P_{D}.

In the present embodiment, a predetermined distance (for example, 5 km) may be set as the radius r_{O} and radius r_{D}, which define the magnitude (size) of the departure point range R_{O} and the destination point range R_{D}. According to the present embodiment, by setting and using a departure point range R_{O} and a destination point range R_{D} having a predetermined range when setting a similar route in this way, avoiding situations in which there is no corresponding similar route within the first piece of driving history information (route), which is accumulated by the driving history accumulation unit 26, is possible, and, consequently, appropriately setting a similar route becomes possible.

Then, in step S403, the similar route searched for in this way is set to be the presentation route. The number of presentation routes is not particularly limited and may be one or a plurality. If a similar route is detected, all of the detected similar routes may be set to be presentation routes, or one, two or more similar routes may be selected from all of the detected similar routes, according to a predetermined condition and selected presentation routes. A predetermined condition may be a method for selecting a similar route that has conditions close to the current conditions and in a consideration of other conditions, such as the travel time period (the season, the temperature), the presence/absence of air conditioner use while traveling, etc. A similar route may also be selected in consideration of the magnitude of the power consumption (for example, selecting similar routes with the maximum and minimum power consumption, etc.).

In step S403, the historical statistics processing unit 27 gives up extracting a similar route when a similar route does not exist in the first piece of driving history information (route) accumulated by the driving history accumulation unit 26, that is, when a route having a travel start point and a travel end point within the departure point range R_{O} and the destination point range R_{D} does not exist.

The operation then proceeds to step S404, and the historical statistics processing unit 27 searches for (selects) similar composite routes, which are composite routes that are identical or similar to the planned route, by referencing composite routes that are generated by combining a plurality of routes accumulated by the driving history accumulation unit 26.

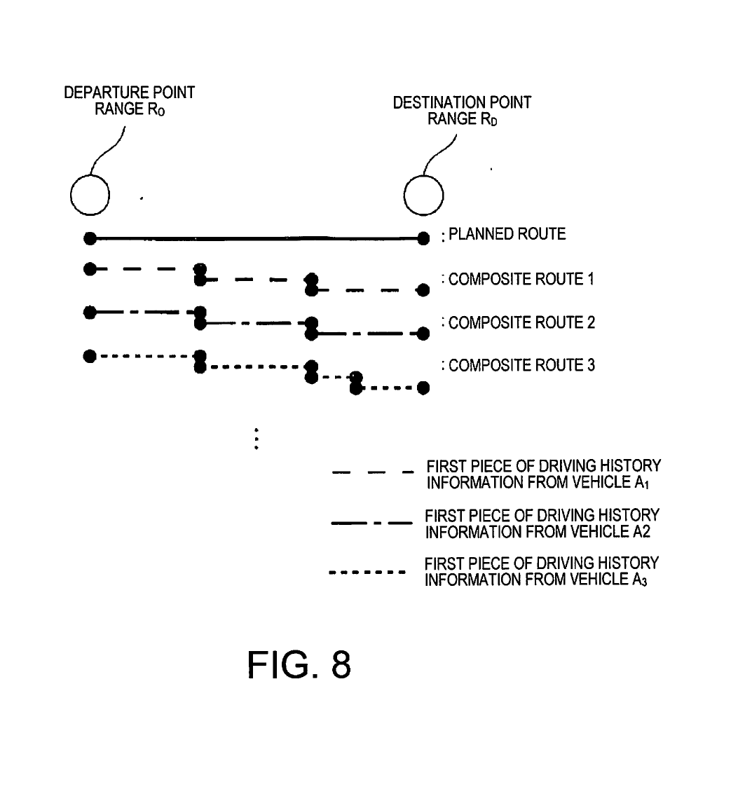

Here, FIG. 8 is an explanatory view representing a composite route. As illustrated in FIG. 8, the historical statistics processing unit 27 extracts information regarding a composite route that is obtained by combining a plurality of routes that were traveled by the same vehicle and extracts a composite route in which the travel start point is within the departure point range R_{O} and the travel end point is within the destination point range R_{D}, which are set in step S403 described above, as a similar composite route.

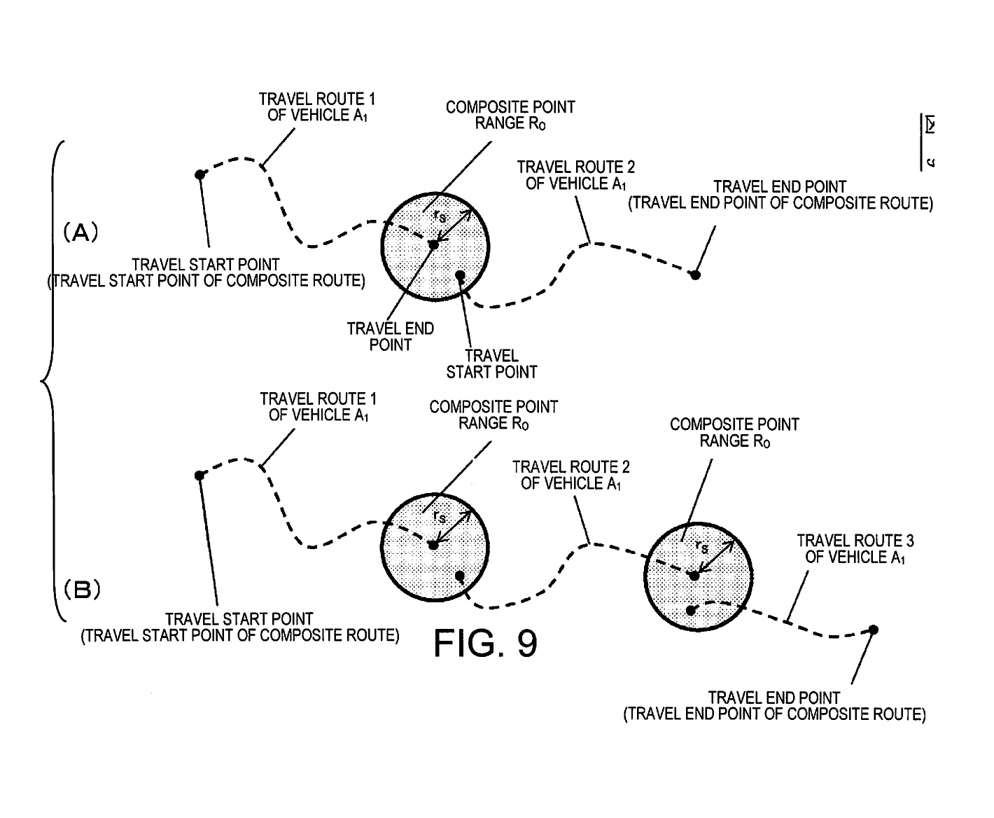

Meanwhile, this type of composite route is generated by the driving history accumulation unit 26 with the following method. Here, FIG. 9 is a view showing one example of a method for generating a composite route, and this method for generating the composite route will be described below, with reference to the example illustrated in FIG. 9. That is, first, the driving history accumulation unit 26 extracts an arbitrary route from among the routes that were traveled by a specific vehicle A₁ by referencing the accumulated first piece of driving history information. For example, the arbitrary route in the example illustrated in part (A) of FIG. 9 is “route 1 of vehicle A₁.” The driving history accumulation unit 26 then sets a circular range having a radius r_{S} from the travel end point of the extracted “route 1 of vehicle A₁” as a composite point range R_{S} and searches for a route having a travel start point within the composite point range R_{S} from among the routes that were traveled by the vehicle A₁. As a result, if a route having a travel start point within the composite point range R_{S} is searched for, the driving history accumulation unit 26 combines these routes, thereby generating a composite route, and accumulates the generated composite route. That is, in the example illustrated in part (A) of FIG. 9, the “route 1 of vehicle A₁” and the “route 2 of vehicle A₁” having travel start points within the composite point range R_{S} are combined, thereby generating a composite route made of “route 1 of vehicle A₁” and “route 2 of vehicle A₁,” which is then accumulated. The radius r_{S} is not particularly limited and may be, for example, around 1-5 km.

In this case, the travel start point and the travel end point of the composite route will be each of the end points of the composite route (the points excluding those points that have been used in the combination operation). That is, in the composite route comprising “route 1 of vehicle A₁” and “route 2 of vehicle A₁” illustrated in part (A) of FIG. 9, the travel start point of “route 1 of vehicle A₁” becomes the travel start point of the composite route, and the travel end point of “route 2 of vehicle A₁” becomes the travel end point of the composite route.

In the example illustrated in part (A) of FIG. 9, an example was shown in which two routes are combined, but the number of combined routes when obtaining a composite route is not limited to two and may be three or more. That is, for example, as in the example illustrated in part (B) of FIG. 9, generating a composite route comprising a “route 1 of vehicle A₁,” “route 2 of vehicle A₁,” and “route 3 of vehicle A₁” is possible by further combining a “route 3 of vehicle A₁” having a travel start point within the composite point range R_{S}, which is a circular range having a radius r_{S} from the travel end point of the “route 2 of vehicle A₁” to a composite route comprising “route 1 of vehicle A₁” and “route 2 of vehicle A₁.” In a composite route obtained in this way, the travel start point of “route 1 of vehicle A₁” becomes the travel start point of the composite route, and the travel end point of “route 3 of vehicle A₁” becomes the travel end point of the composite route.

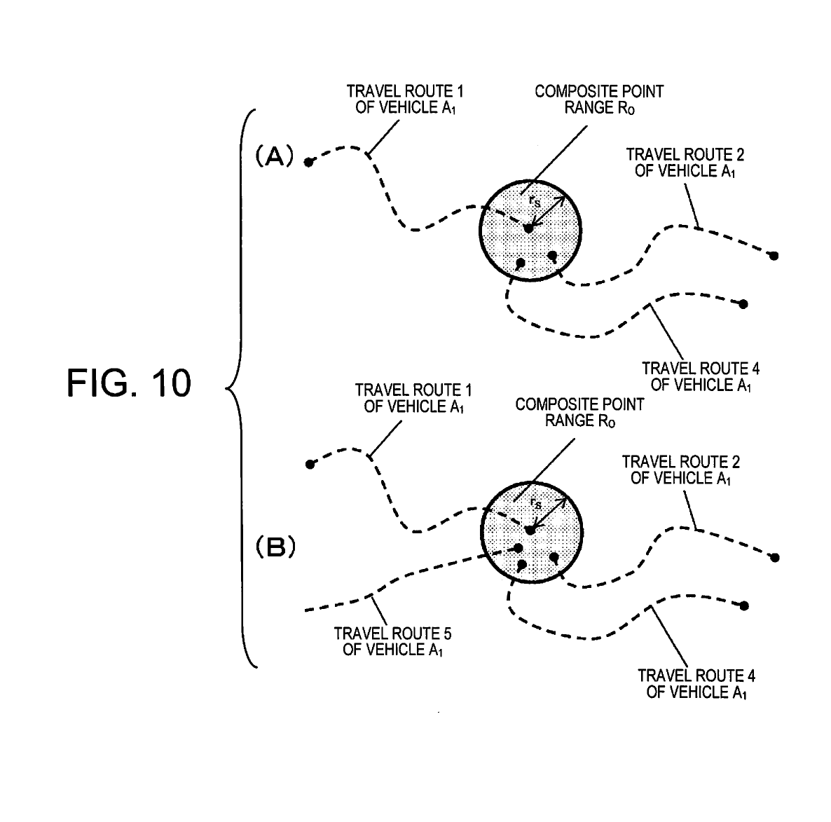

Additionally, as illustrated in the example in part (A) of FIG. 10, when two routes having a travel start point within a composite point range R_{S}, which is a circular range having a radius r_{S} from the travel end point of “route 1 of vehicle A₁,” such as “route 2 of vehicle A₁” and “route 4 of vehicle A₁,” exist, generating a composite route comprising “route 1 of vehicle A₁” and “route 4 of vehicle A₁,” in addition to a composite route comprising “route 1 of vehicle A₁” and “route 2 of vehicle A₁,” is possible. That is, in this case, generating two composite routes from three routes of the vehicle A1 is possible. In the example illustrated in part (A) of FIG. 10, an example was shown in which two routes having a travel start point within a composite point range R_{S}, which is a circular range having a radius r_{S} from the travel end point of “route 1 of vehicle A1” exist, but the same method can be applied when there are three or more routes as well. Here, FIG. 10 is a view showing one example of a method for generating a composite route.

Also, as illustrated in the example of part (B) of FIG. 10, when four routes exist, generating four composite routes is possible: a composite route comprising “route 1 of vehicle A₁” and “route 2 of vehicle A₁;” a composite route comprising “route 1 of vehicle A₁” and “route 4 of vehicle A₁;” a composite route comprising “route 5 of vehicle A₁” and “route 2 of vehicle A₁;” and a composite route comprising “route 5 of vehicle A₁” and “route 4 of vehicle A₁.”

In the description above, an example was explained in which a composite route is generated regarding a specific vehicle A₁; however, as illustrated in FIG. 8, the driving history accumulation unit 26 generates a composite route for each vehicle by combining the plurality of routes that were traveled by vehicle A₂, vehicle A₃, etc., besides vehicle A₁, and the driving history accumulation unit 26 accumulates a plurality of composite routes combined for each vehicle by storing the composite routes generated in this way.

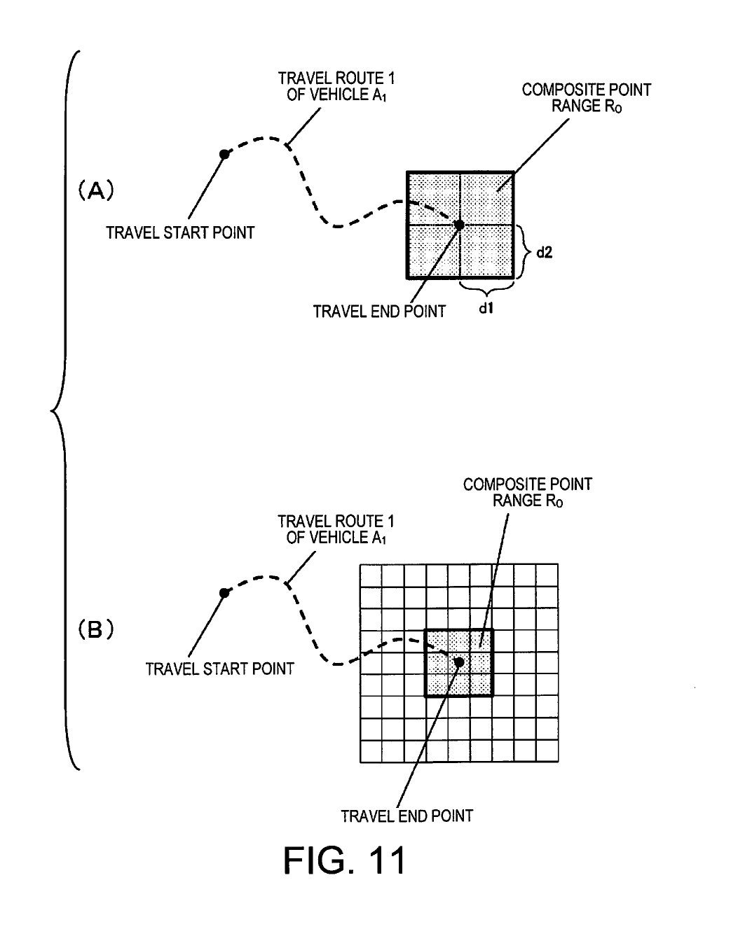

In the example described above, an example was explained in which a circular range having a radius r_{S} from the travel end point of an arbitrary route is set as the composite point range R_{S} and a route having a travel start point within the composite point range R_{S} is combined; however, a rectangular range configured from ±d1 latitude and ±d2 longitude about the travel end point may also be set as the composite point range R_{S}, as illustrated in part (A) of FIG. 11. That is, for example, when the latitude and longitude of the travel end point are assumed to be (latitude, longitude)=(x, y), the rectangular area defined by (x−d1, y−d2), (x+d1, y−d2), (x−d1, y+d2), (x+d1, y+d2) may be set as the composite point range R_{S}. The variables d1 and d2 may be, for example, the same as the above-described radius r_{S}.

Alternatively, a grid that is made by delimiting the latitude and longitude on a map per a predetermined step can be formed, and nine grid areas about grids in positions of the travel end points of arbitrary routes may be set as the composite point ranges R_{S}. That is, in the example illustrated in part (B) of FIG. 11, the travel end points are indexed in the range of the grid to which the travel end point belongs, and the eight grids are adjacent to this grid, which comprise the composite point range R_{S}. Examples of methods for delimiting the grids include a method for arbitrarily setting the latitude and longitude, such as setting them every 0.1 degrees, or a method for following commonly used map grid code, piano code, geohash, geohex, etc. may be employed. More simply setting a composite point range R_{S} by employing this type of method is possible, and, as a result, reducing the calculation load when generating a composite route is possible.

Additionally, as the composite point range R_{S}, a range in which the path on a road network that starts at the travel end point becomes a predetermined equal distance (for example, 5 km) may be set, or a range that is within a predetermined distance range from the travel end point and that is within a predetermined altitude range in relation to the altitude of the travel end point may also be set.

Then, in step S404, the historical statistics processing unit 27 extracts a composite route, in which the travel start point is within the departure point range R_{O} and the travel end point is within the destination point range R_{D}, which are set in step S403 described above, within the composite routes that are combined and accumulated by the driving history accumulation unit 26 in this way, as a similar composite route; the historical statistics processing unit then determines the extracted similar composite route to be the presentation route. When these types of similar composite routes (composite routes having a route within the departure point range R_{O} and a travel end point within the destination point range R_{D}) are detected, all of the detected similar composite routes may be set as presentation routes, or one, two or more similar composite routes may be selected, according to a predetermined condition, and made to be presentation routes. A predetermined condition may be a method for selecting a similar composite route that has conditions close to the current conditions in consideration of conditions, such as the travel time period (the season, the temperature), the presence/absence of air conditioner use while traveling, etc. A similar composite route may also be selected in consideration of the magnitude of the power consumption (for example, selecting similar routes with the maximum and minimum power consumption, etc.).

In step S404, the historical statistics processing unit 27 gives up extracting a similar composite route when a composite route having a travel start point and a travel end point within the departure point range R_{O} and the destination point range R_{D} does not exist among the composite routes accumulated in the driving history accumulation unit 26.

The operation then proceeds to step S405, and the historical statistics processing unit 27 determines whether or not a presentation route (a similar route or a similar composite route) has been selected in the above-described steps S403, S404. Then, if the historical statistics processing unit 27 determines that a presentation route (a similar route or a similar composite route) has been selected (step S405=Yes), the operation proceeds to step S406. On the other hand, if the historical statistics processing unit 27 determines that a presentation route (a similar route or a similar composite route) has not been selected (step S405=No), the operation proceeds to step S408.

If a determination is made that a presentation route (a similar route or a similar composite route) has been determined in step S405, the operation proceeds to step S406; in step S406, the historical statistics processing unit 27 extracts the charging hubs that were traversed when driving along the presentation routes (the similar routes or the similar composite routes) determined in the above-described steps S403, S404 from the second piece of driving history information (charging hubs) accumulated by the driving history accumulation unit 26. For example, if a presentation route, which is a similar route, has been selected in the above-described step S403, the historical statistics processing unit 27 searches for the first piece of driving history information that includes the similar routes within the first piece of driving history information that is accumulated by the driving history accumulation unit 26. Next, the historical statistics processing unit 27 extracts the charging hubs from the second piece of driving history information that is associated with the searched for first piece of driving history information within the second piece of driving history information (charging hubs) that is accumulated by the driving history accumulation unit 26. If a presentation route, which is a similar composite route, has been selected in the above-described step S404, the historical statistics processing unit 27 searches for the first piece of driving history information that includes the routes that form the similar composite routes within the first piece of driving history information that is accumulated by the driving history accumulation unit 26. Next, the historical statistics processing unit 27 extracts the charging hub information from the second piece of driving history information that is associated with the searched for first piece of driving history information within the second piece of driving history information (the charging hub information) that is accumulated by the driving history accumulation unit 26. The historical statistics processing unit 27 then makes each of the extracted charging hubs the charging hubs that were traversed when driving along the presentation route (the similar route or the similar composite route) determined in the above-described steps S403, S404.

The operation then proceeds to step S410, and the historical statistics processing unit 27 extracts the power that is consumed when driving along the presentation route (a similar route or a similar composite route) determined in the above-described steps S403, S404 within the first piece of driving history information (the power consumption information) that is accumulated by the driving history accumulation unit 26. For example, if a presentation route, which is a similar route, has been selected in the above-described step S403, the historical statistics processing unit 27 extracts the power consumption information from the first piece of driving history information that includes the similar route. If a presentation route, which is a similar composite route, has been selected in the above-described step S404, the power consumption information is extracted from each of a plurality of first pieces of driving history information that includes the routes that form the similar composite routes. The historical statistics processing unit 27 then calculates the sum of the extracted power consumption, the power that was consumed when driving the similar composite routes.

If a determination is made in step S405 that a presentation route (a similar route or a similar composite route) was selected, the operation proceeds to step S408; in step S408, the historical statistics processing unit 27 calculates the power that is consumed when driving along the planned route that is searched for in step S401 described above (hereinafter also referred to as the theoretical power consumption), based on the theoretical performance of the host vehicle A. Specifically, the historical statistics processing unit 27 makes the product of multiplying the power consumption per a predetermined unit of distance by the total length of the planned route the theoretical power consumption, and the operation proceeds to step S410.

The operation then proceeds to step S409, and the historical statistics processing unit 27 extracts the position of a charging facility C that exists in the vicinity of the planned route that is searched for in the above-described step S401, based on the map information that is stored by the map information storage unit 25; subsequently, the operation proceeds to step S410. The charging facility C that exists in the vicinity of the planned route may be a charging facility C that exists along the planned route, or a charging facility C that is within a set distance (for example, 20 m) from the planned route, etc.

Next, in step S410, the historical statistics processing unit 27 executes a charging hub extraction operation based on the battery level acquired in the above-described step S402. In the charging hub extraction operation, the historical statistics processing unit 27 extracts the charging hubs that are transmitted (provided) to the source terminal device 2 from the charging hubs acquired in step S406 or S409 described above. An example of a source terminal device 2 may be, for example, the terminal device 2 of the transmission source of the presentation route search request, which acted as a trigger to start this historical statistics processing step. Additionally, in the charging hub extraction operation, the possibility that the vehicle A cannot reach the destination point is determined; when a determination is made that there is a possibility that the vehicle will not reach the destination, an unreachable warning, which provides a warning to that effect, will be issued. The details of the charging hub extraction operation will be described below.

The operation then proceeds to step S411, and the historical statistics processing unit 27 executes a power consumption correction operation, based on the power consumption trends of the driver of the vehicle A. In the power consumption correction operation, the historical statistics processing unit 27 calculates the power that is consumed when driving along the presentation route (a similar route, a similar composite route) by referencing the first piece of driving history information of the driver that is specified by the driver ID, which includes the presentation route search request, from the first piece of driving history information that is accumulated by the driving history accumulation unit 26. The historical statistics processing unit 27 then corrects the power consumption extracted in step S406 or S409 described above, based on the calculated power consumption. The details of the power consumption correction operation will be described below.

The operation then proceeds to step S412, and the historical statistics processing unit 27 transmits (provides) to the source terminal device 2 the presentation route (a similar route, a similar composite route) selected in steps S403 or S404 described above, the charging hubs extracted in step S410 described above, and information regarding the power consumption that was corrected in step S411 described above; subsequently, the driving history statistical processing step ends. If a presentation route could not be extracted in steps S403, S404 described above, the historical statistics processing unit 27 transmits information regarding the planned route searched for in the above-described step S401, the charging hubs extracted in the above-described step S410, and the power consumption (the theoretical power consumption) calculated in the above-described step S408. If an unreachable warning is issued in the above-described step S410, the historical statistics processing unit 27 also transmits (provides) a control command to display the unreachable warning to the source terminal device 2.

In the present embodiment, an example was described in which information regarding the charging hubs extracted in the above-described step S410 and the power consumption that is corrected in the above-described step S411 is transmitted (provided) to the source terminal device 2; however, another configuration may also be employed. For example, the configuration may transmit (provide) information regarding the charging hubs acquired in step S406 or S409 described above and the power consumption before correction in the above-described step S412 to the source terminal device 2.

Charging Hub Extraction Operation

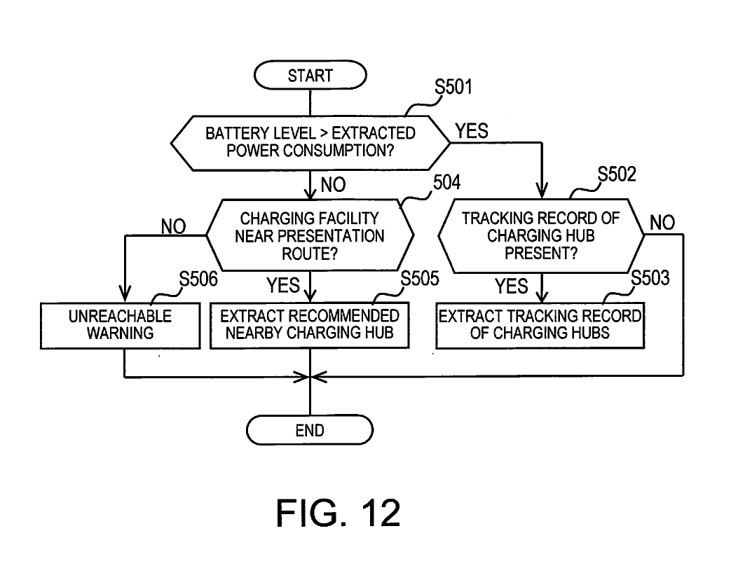

Next, the charging hub extraction operation that is executed by the historical statistics processing unit 27 will be described. When the operation proceeds to step S410 in the above-described driving history statistical processing step, the historical statistics processing unit 27 executes a charging hub extraction operation. FIG. 12 is a flowchart representing the charging hub extraction operation.

First, in step S501, the historical statistics processing unit 27 determines whether or not the battery level acquired in the above-described step S402 is greater than the power consumption extracted in step S407 or S408 described above (hereinafter also referred to as the extracted power consumption), as illustrated in FIG. 12. Then, if the historical statistics processing unit 27 determines that the battery level is greater than the extracted power consumption (step S501=Yes), the operation proceeds to step S502. On the other hand, if the historical statistics processing unit 27 determines that the battery level is equal to or less than the extracted power consumption (step S501=No), the operation proceeds to step S505.

When a determination is made that the battery level is greater than the extracted power consumption in step S501, the operation proceeds to step S502; in step S502, the historical statistics processing unit 27 determines whether or not there is a tracking record of a charging hub within the charging hubs acquired in step S406 or S409 described above by referencing the second piece of driving history information (charging hubs) accumulated by the driving history accumulation unit 26. A tracking record of a charging hub may be a location of a charging facility C at which at least one of a plurality of vehicles A has actually performed charging. Then, if the historical statistics processing unit 27 determines that there is a tracking record of a charging hub (step S502=Yes), the operation proceeds to step S503. On the other hand, if the historical statistics processing unit 27 determines that there is no tracking record of a charging hub (step S502=No), a charging hub is not extracted, and the charging hub extraction operation ends. The historical statistics processing unit 27 thereby does not transmit (provide) information regarding a tracking record of charging hubs to the source terminal device 2 when the battery level of the battery 14 for running the vehicle is sufficient and when there is no tracking record of a charging hub among the charging hubs acquired in step S406 or S409 described above. Since, conceivably, a tracking record of a charging hub is a private charging facility of a particular individual or a corporation, preferentially extracting facilities that are without a doubt public charging facilities, as determined through statistical processing, is desirable. For example, a method in which the configuration has a separate database for public charging facilities and for those with a track record in the same locations from which these data have been extracted may be conceived, or a method for extracting charging facilities having a charging track record, in which a plurality of vehicles (for example, equal to or greater than five) owned by different entities (including corporations and individuals) have charged at the same location, may be conceived. Additionally, making selections so that the charging facilities that can actually be utilized during the estimated arrival time zone at the hubs are preferentially traversed is possible by considering the available time zones when utilizing these data.

On the other hand, when a determination is made that there is a track record charging hub, the operation proceeds to step S503; in step S503, the historical statistics processing unit 27 extracts the track record charging hubs from the charging hubs acquired in step S406 or S409 described above by referencing the second piece of driving history information (charging hubs) accumulated by the driving history accumulation unit 26, after which the charging hub extraction operation ends. The historical statistics processing unit 27 thereby transmits (provides) information only regarding the track record charging hubs to the source terminal device 2 when the battery level of the battery 14 for running the vehicle is sufficient and when there is a track record charging hub among the charging hubs acquired in step S406 or S409 described above.

When a determination is made that the battery level is equal to or less than the extracted power consumption in the above-described step S501, the operation proceeds to step S504; in step S504, the historical statistics processing unit 27 determines whether or not a charging facility C exists in the vicinity of the presentation route (a similar route, a similar composite route) determined in the step S403 or S404 described above, based on the map information stored by the map information storage unit 25. The charging facility C that exists in the vicinity of the presentation route may be a charging facility C that exists along the presentation route or a charging facility C that is within a set distance (for example, 20 m) from the presentation route, etc. If the historical statistics processing unit 27 determines that a charging facility C exists in the vicinity of the presentation route (step S504=Yes), the operation proceeds to step S505. On the other hand, if the historical statistics processing unit 27 determines that a charging facility C does not exist in the vicinity of the presentation route (step S504=No), the operation proceeds to step S506.

If a presentation route could not be determined in step S403 or S404 described above, the historical statistics processing unit 27 determines whether or not a charging facility C exists in the vicinity of the planned route searched for in the above-described step S401, based on the map information that is stored by the map information storage unit 25. If the historical statistics processing unit 27 determines that a charging facility C exists in the vicinity of the planned route (step S504=Yes), the operation proceeds to step S505. On the other hand, if the historical statistics processing unit 27 determines that a charging facility C does not exist in the vicinity of the planned route (step S504=No), the operation proceeds to step S506.

When a determination is made that a charging facility C exists in the vicinity of the presentation route in step S504, the operation proceeds to step S505; in step S505, the historical statistics processing unit 27 extracts the position of the charging facility C that exists in the vicinity of the presentation route (a similar route, a similar composite route) (hereinafter also referred to as the recommended nearby charging hub), based on the map information that is stored by the map information storage unit 25; subsequently, the charging hub extraction operation ends. If a presentation route (a similar route, a similar composite route) could not be extracted in step S403 or S404 described above, the historical statistics processing unit 27 extracts the recommended nearby charging hubs that are present in the vicinity of the planned route, based on the map information that is stored by the map information storage unit 25. The historical statistics processing unit 27 thereby transmits (provides) to the source terminal device 2 only information regarding the recommended nearby charging hubs when the battery level of the battery 14 for running the vehicle is insufficient and when there is a recommended nearby charging hub present.

On the other hand, when a determination is made that a charging facility C does not exist in the vicinity of the presentation route in step S504, the operation proceeds to step S506; in step S506, the historical statistics processing unit 27 issues an unreachable warning, after which the charging hub extraction operation ends. The historical statistics processing unit 27 thereby does not transmits (provide) to the source terminal device 2 information regarding the recommended nearby charging hubs (the charging hubs) when the battery level of the battery 14 for running the vehicle is insufficient and when a recommended nearby charging hub is not present.

Power Consumption Correction Operation

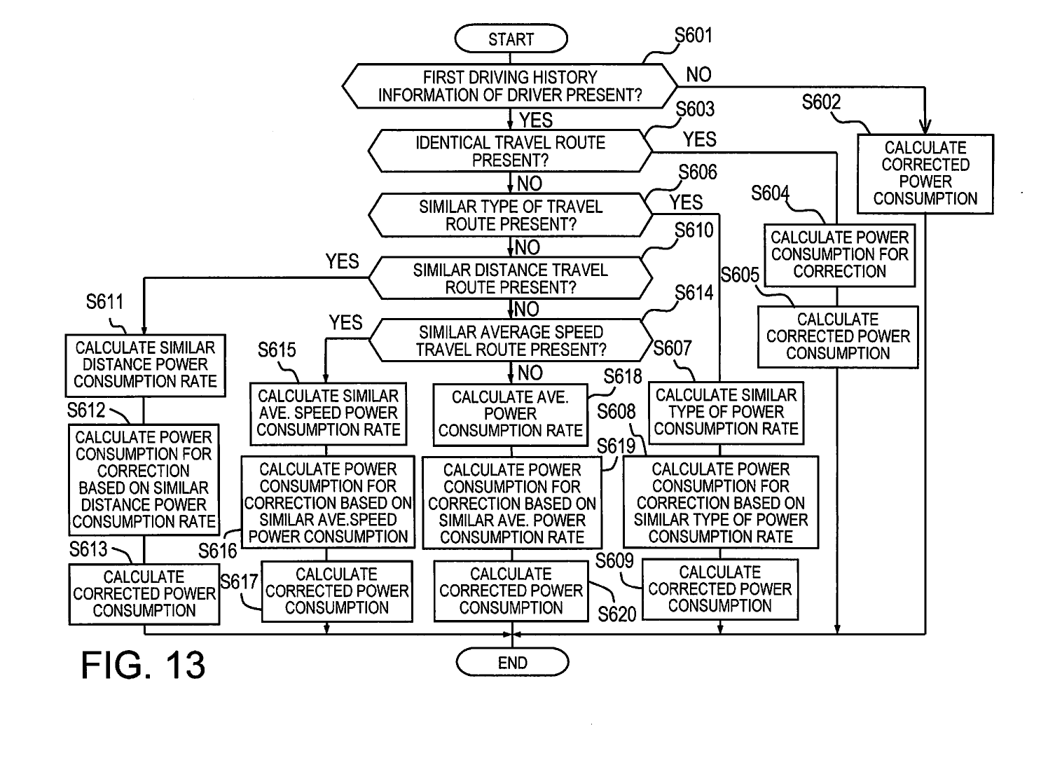

Next, the power consumption correction operation that is executed by the historical statistics processing unit 27 will be described. When the operation proceeds to step S411 in the above-described driving history statistical processing step, the historical statistics processing unit 27 executes a power consumption correction operation. FIG. 13 is a flowchart representing the power consumption correction operation.

First, in step S601, the historical statistics processing unit 27 acquires the driver ID (information identifying the driver) based on the received presentation route search request, as illustrated in FIG. 13. Next, the historical statistics processing unit 27 determines whether or not there is a first piece of driving history information that includes a driver ID that is identical to the acquired driver ID (hereinafter also referred to as the source driving history information) within the first piece of driving history information that is accumulated by the driving history accumulation unit 26. Then, if the historical statistics processing unit 27 determines that there is source driving history information (step S601=Yes), the operation proceeds to step S603. On the other hand, if the historical statistics processing unit 27 determines that there is no source driving history information (step S601=No), the operation proceeds to step S602.

When a determination is made that there is source driving history information in step S601, the operation proceeds to step S602; in step S602, the historical statistics processing unit 27 sets the power consumption calculated in step S407 or S408 described above as the corrected power consumption as is (hereinafter also referred to as the corrected power consumption), and the power consumption correction operation ends. The historical statistics processing unit 27 thereby transmits (provides) to the source terminal device 2 information regarding the power consumption calculated in step S407 or S409 described above as is when source driving history information does not exist within the first piece of driving history information that is accumulated by the driving history accumulation unit 26.

On the other hand, if a determination is made that source driving history information does not exist in step S601, the operation proceeds to step S603; in step S603, the historical statistics processing unit 27 determines whether or not there is a route that is identical to the similar route that is extracted in the above-described step S403 within the source driving history information (route) that is accumulated by the driving history accumulation unit 26 (hereinafter also referred to as the identical route). Then, if the historical statistics processing unit 27 determines that there is an identical route (step S603=Yes), the operation proceeds to step S604. On the other hand, if the historical statistics processing unit 27 determines that there is no identical route (step S603=No), the operation proceeds to step S606. An identical route may be any route that can be determined to be identical to the similar route that is extracted in the above-described step S403; there may be discrepancies as long as the errors can be determined to be within the margin for error.

When a determination is made that there is an identical route in step S603, the operation proceeds to step S604; in step S604, the historical statistics processing unit 27 extracts the power that was consumed when driving the identical route from the source driving history information that is accumulated by the driving history accumulation unit 26. Next, the historical statistics processing unit 27 sets the extracted power consumption as the power consumption for correction.

The operation then proceeds to step S605, and the historical statistics processing unit 27 corrects the power consumption that is calculated in step S407 or S408 described above, based on the power consumption for correction calculated in the above-described step S604. Examples of a method for correcting the power consumption include a method for replacing the power consumption with the power consumption for correction; a method for calculating the average value of the power consumption and the power consumption for correction; and a method for using the difference c between the power consumption b and the power consumption for correction a and expressing this as a+c. Next, the historical statistics processing unit 27 sets the power consumption that has been corrected as the corrected power consumption, after which the power consumption correction operation ends. The historical statistics processing unit 27 thereby makes a correction using the power that was consumed when driving the identical route and transmits (provides) the corrected power consumption to the source terminal device 2 when there is an identical route within the source driving history information that is accumulated by the driving history accumulation unit 26.

On the other hand, when a determination is made that there is no identical route in step S603 described above, the operation proceeds to step S606; in step S606, the historical statistics processing unit 27 determines whether or not there is a similar type of route within the source driving history information (route) that is accumulated by the driving history accumulation unit 26. A similar type of route may be, for example, a route that has an identical or similar road type as the presentation route (a similar route, a similar composite route) that is selected in step S403 or S404 described above. If a presentation route (a similar route, a similar composite route) could not be selected in the steps S403, S404 described above, the planned route that is searched for in the above-described step S401 is set as a similar type of route. Then, if the historical statistics processing unit 27 determines that there is a similar type of route (step S606=Yes), the operation proceeds to step S607. On the other hand, if the historical statistics processing unit 27 determines that there is no similar type of route (step S606=No), the operation proceeds to step S610.

When a determination is made that there is a similar type of route in step S606, the operation proceeds to step S607; in step S607, the historical statistics processing unit 27 calculates the power consumption per unit of distance of the similar type of route (hereinafter also referred to as the similar type power consumption rate) by referencing the source driving history information that is accumulated by the driving history accumulation unit 26.

The operation then proceeds to step S608, and the historical statistics processing unit 27 multiplies the similar type power consumption rate calculated in the step S607 described above by the total length of the planned route. Then, the historical statistics processing unit 27 sets the product as the power consumption for correction.

The operation then proceeds to step S609, and the historical statistics processing unit 27 corrects the power consumption that is calculated in step S407 or S408 described above, based on the power consumption for correction calculated in the above-described step S608. The method for correcting the power consumption may be the same method as that described in the above step S605. Next, the historical statistics processing unit 27 sets the power consumption that has been corrected as the corrected power consumption, after which the power consumption correction operation ends. The historical statistics processing unit 27 thereby corrects the power consumption using the similar type power consumption rate and transmits (provides) the corrected power consumption to the source terminal device 2 when there is a similar type of route within the source driving history information that is accumulated by the driving history accumulation unit 26.

On the other hand, when a determination is made that there is no similar type of route in step S606 described above, the operation proceeds to step S610; in step S610, the historical statistics processing unit 27 determines whether or not there is a similar distance route within the source driving history information (route) that is accumulated by the driving history accumulation unit 26. A similar distance route may be, for example, a route that has an identical or similar total length as the presentation route (a similar route, a similar composite route) that is selected in step S403 or S404 described above. If a presentation route (a similar route, a similar composite route) could not be selected in the steps S403, S407 described above, the planned route that is searched for in the above-described step S401 is set as a similar distance route. For example, the historical statistics processing unit 27 determines whether or not there is a route with a different total length, when compared to the presentation route, that is less than a predetermined value (for example, ±100 m) within the source driving history information (route) that is accumulated by the driving history accumulation unit 26. Then, if the historical statistics processing unit 27 determines that there is a similar distance route (step S610=Yes), the operation proceeds to step S611. On the other hand, if the historical statistics processing unit 27 determines that there is no similar distance route (step S610=No), the operation proceeds to step S614.

When a determination is made that there is a similar distance route in step S610, the operation proceeds to step S611; in step S611, the historical statistics processing unit 27 calculates the power consumption per unit of distance of the similar distance route (hereinafter also referred to as the similar distance power consumption rate) by referencing the source driving history information that is accumulated by the driving history accumulation unit 26.

The operation then proceeds to step S612, and the historical statistics processing unit 27 multiplies the similar distance power consumption rate calculated in the step S611 described above by the total length of the planned route. Then, the historical statistics processing unit 27 sets the product as the power consumption for correction.

The operation then proceeds to step S613, and the historical statistics processing unit 27 corrects the power consumption that is calculated in step S407 or S408 described above, based on the power consumption for correction calculated in the above-described step S612. The method for correcting the power consumption may be the same method as that described in the above step S605. Next, the historical statistics processing unit 27 sets the power consumption that has been corrected as the corrected power consumption, after which the power consumption correction operation ends. The historical statistics processing unit 27 thereby corrects the power consumption using the similar distance power consumption rate and transmits (provides) the corrected power consumption to the source terminal device 2 when there is a similar distance route within the source driving history information that is accumulated by the driving history accumulation unit 26.

On the other hand, when a determination is made that there is no similar distance route in step S610 described above, the operation proceeds to step S614; in step S614, the historical statistics processing unit 27 determines whether or not there is a similar average speed route within the source driving history information (route) that is accumulated by the driving history accumulation unit 26. A similar average speed route may be, for example, a route that has an identical or similar average speed as the presentation route (a similar route, a similar composite route) that is selected in step S403 or S404 described above. If a presentation route (a similar route, a similar composite route) could not be selected in the steps S403, S404 described above, the planned route that is searched for in the above-described step S401 is set as a similar average speed route. For example, the historical statistics processing unit 27 determines whether or not there is a route with a different average speed, when compared to the presentation route, that is less than a predetermined value (for example, +5 km/h) within the source driving history information (route) that is accumulated by the driving history accumulation unit 26. Then, if the historical statistics processing unit 27 determines that there is a similar average speed route (step S614=Yes), the operation proceeds to step S615. On the other hand, if the historical statistics processing unit 27 determines that there is no similar average speed route (step S614=No), the operation proceeds to step S618.

When a determination is made that there is a similar average speed route in step S614, the operation proceeds to step S615; in step S615, the historical statistics processing unit 27 calculates the power consumption per unit of distance of the similar average speed route (hereinafter also referred to as the similar average speed power consumption rate) by referencing the source driving history information that is accumulated by the driving history accumulation unit 26.

The operation then proceeds to step S616, and the historical statistics processing unit 27 multiplies the similar average speed power consumption rate calculated in the step S615 described above by the total length of the planned route. Then, the historical statistics processing unit 27 sets the product as the power consumption for correction.

The operation then proceeds to step S617, and the historical statistics processing unit 27 corrects the power consumption that is calculated in step S407 or S408 described above, based on the power consumption for correction calculated in the above-described step S616. The method for correcting the power consumption may be the same method as that described in the above step S605. Next, the historical statistics processing unit 27 sets the power consumption that has been corrected as the corrected power consumption, after which the power consumption correction operation ends. The historical statistics processing unit 27 thereby corrects the power consumption using the similar average vehicle speed power consumption rate and transmits (provides) the corrected power consumption to the source terminal device 2 when there is a similar average speed route within the source driving history information that is accumulated by the driving history accumulation unit 26.

On the other hand, when a determination is made that there is no similar average speed route in step S614, the operation proceeds to step S618; in step S618, the historical statistics processing unit 27 calculates the average value of the power consumption per unit of distance of all of the routes of the source driving history information (hereinafter also referred to as the average power consumption rate) by referencing the source driving history information that is accumulated by the driving history accumulation unit 26.

The operation then proceeds to step S619, and the historical statistics processing unit 27 multiplies the average power consumption rate calculated in the step S618 described above by the total length of the planned route. Then, the historical statistics processing unit 27 sets the product as the power consumption for correction.

The operation then proceeds to step S620, and the historical statistics processing unit 27 corrects the power consumption that is calculated in step S407 or S408 described above, based on the power consumption for correction calculated in the above-described step S619. The method for correcting the power consumption may be the same method as that described in the above step S605. Next, the historical statistics processing unit 27 sets the power consumption that has been corrected as the corrected power consumption, after which the power consumption correction operation ends. The historical statistics processing unit 27 thereby corrects the power consumption using the average power consumption rate and transmits (provides) the corrected power consumption to the source terminal device 2 when all of the determinations of the steps S603, S606, S610, and S614 described above are “No.”

In this way, in the present embodiment, the historical statistics processing unit 27 calculates the power that is consumed when driving along the searched planned route, based on the first piece of driving history information for a specified driver, from among the first pieces of driving history information that is accumulated by the driving history accumulation unit 26. The historical statistics processing unit 27 then corrects the extracted power consumption, based on the calculated power consumption. Next, the historical statistics processing unit 27 provides information regarding the corrected power consumption. For this reason, acquiring power consumption information that takes into consideration the driving characteristics of the driver is possible. For this reason, providing more appropriate power consumption information is possible.

As described above, in the present embodiment, the vehicle information providing device 3 sequentially acquires at least one of driving location information, power consumption information and charging location information from a vehicle-mounted device 1, which is installed in a vehicle A that has an electric motor 13 as a drive source, and accumulates this information as the driving history information (the first piece of driving history information, the second piece of driving history information). The vehicle information providing device 3 then refers to the accumulated first piece of driving history information, searches for a similar route and a similar composite route that are either identical or similar to a planned route, and sets the detected similar route and similar composite route as a presentation route. The vehicle information providing device 3 then refers to the accumulated first piece of driving history information and second piece of driving history information and detects the power that is consumed when driving along the determined presentation route (the similar route, the similar composite route) and the charging hubs that will be traversed when driving along the presentation route (the similar route, the similar composite route). Next, the vehicle information providing device 3 provides information regarding the determined presentation route (the similar route, the similar composite route), as well as information regarding the determined power consumption and charging hubs. Accordingly, providing power consumption information and charging hub information that are more in accordance with the actual environment is possible.

In the present embodiment, an example was described in which the vehicle information providing device 3 determines (extracts) both the power that was consumed when a vehicle A actually drove a presentation route (the similar route, the similar composite route), as well as the charging hubs; however, another configuration may also be used. For example, the vehicle information providing device 3 may be configured to determine at least the power consumption or the charging hubs. In this case, the vehicle information providing device 3 provides (transmits) only the power consumption or the charging hub information that has been determined, along with the presentation route (the similar route, the similar composite route).

According to the present embodiment, an vehicle information providing device 3 sequentially acquires at least one of driving location information, power consumption information and charging location information from a vehicle-mounted device 1, which is installed in a vehicle A that has an electric motor 13 as a drive source, and accumulates this information as the driving history information (the first piece of driving history information, the second piece of driving history information). The vehicle information providing device 3 then refers to the accumulated first piece of driving history information; referring to information regarding the travel start point and the travel end point of each route, which is included in the first piece of driving history information, a composite route is generated by combining routes whose travel end points and travel start points are within the predetermined composite point range R_{S}. The vehicle information providing device 3 searches for a similar route, which is identical or similar to a planned route, from a departure point P_{O} to a destination point P_{D}, and a composite route that is identical or similar to a planned route from a departure point P_{O} to a destination point P_{D} and sets the these as the presentation routes. The vehicle information providing device 3 then refers to the accumulated first piece of driving history information and second piece of driving history information and detects the power that is consumed when driving along the determined presentation route and the charging hubs that will be traversed when driving along the presentation route. Next, the vehicle information providing device 3 provides the information regarding the determined presentation route, as well as that regarding at least the determined power consumption or the charging hubs. According to the present embodiment, power that is consumed when a vehicle A travels and charging hubs are determined with reference to the driving history information, that is, the information that is acquired while the vehicle A actually travels; as a result, providing information regarding the power consumption that is in accordance with the actual environment and information regarding charging hubs is possible according to the present invention. In particular, according to the present embodiment, when selecting the presentation route, a composite route generated by combining the routes whose travel end points and travel start points are within a predetermined composite point range R_{S}, in addition to a route that one vehicle traveled once (a single route), become the targets of the search; as a result, determining a more appropriate presentation route is possible. Accordingly, providing power consumption information and charging hub information that are more in accordance with the actual environment is possible.

A second embodiment of the present invention will be explained next. As described below, in a vehicle information provision system S illustrated in FIG. 1, besides being different from the first embodiment in the point that the travel conditions of the routes to be combined must be within a predetermined range, and in addition to having a travel start point within a composite point range R_{S}, which is a circular range having a radius r_{S} from the travel end point, when a plurality of routes traveled by the same vehicle are combined to generate a composite route, the second embodiment comprises the same configuration and exerts the same effects as the first embodiment described above.

That is, taking the scene illustrated in part (A) of FIG. 10 as an example, in this example scene, two routes, “route 2 of vehicle A₁” and “route 4 of vehicle A₁” having travel start points within a composite point range R_{S}, which is a circular range having a radius r_{S} from the travel end point of “route 1 of vehicle A₁” exist. Additionally, in this example scene, when the travel conditions of “route 2 of vehicle A₁” are within a predetermined range in relation to the travel conditions of “route 1 of vehicle A₁,” the driving history accumulation unit 26 combines the above and generates a composite route comprising “route 1 of vehicle A₁” and “route 4 of vehicle A₁.” On the other hand, however, when the travel conditions of “route 4 of vehicle A₁” are not within the predetermined range in relation to the travel conditions of “route 1 of vehicle A₁,” the driving history accumulation unit 26 will not combine these routes.

In the present embodiment, examples of such travel conditions include one or more of the following: the travel time zone, the driving speed, the driving altitude, the day of week, the season, the temperature, the weather, and the air conditioner power consumption. For instance, using an example of the condition of the “travel time zone” from the above, if the “travel time zone” of “route 1 of vehicle A₁” is 7 AM-8 AM, and the “travel time zone” of “route 2 of vehicle A₁” is 8 AM-9 AM, the congestion status of these roads is considered to be about the same; as a result, a determination can be made that the travel conditions are relatively close; for this reason, in such a case, a composite route is generated. On the other hand, if, for example, the “travel time zone” of “route 4 of vehicle A₁” is 10 PM-11 PM, there is a high likelihood that the congestion status in relation to the “route 1 of vehicle A₁” will be different; as a result, a determination can be made that the travel conditions will be relatively different; for this reason, in such a case, a composite route will not be generated. In particular, since there is a high likelihood that the power consumption will be different between such routes with relatively different travel conditions, there are cases in which the power consumption information that is in line with the actual environment is difficult to obtain. For this reason, in the present embodiment, a composite route is not generated in such cases.

Regarding travel conditions besides the “travel time zone,” for example, regarding the condition of the “day of week,” an assumption can be made that, even if the travel time zone is the same, the congestion state of the road will be different on Mondays through Fridays, as compared to Saturdays and Sundays. Regarding the condition of the “season,” the condition of the “temperature,” and the condition of the “weather,” when these conditions differ, the power consumption of the air conditioner will differ; for this reason, there is a likelihood that the power consumption will be different.

Thus, in the present embodiment, in consideration of these travel conditions, the driving history accumulation unit 26 is configured to not generate a composite route when the travel conditions are not within a predetermined range.

In addition, in the present embodiment, even when generating a composite route, the driving history accumulation unit 26 compares the travel conditions of the combined routes and sets priority P for each composite route according to the degree of similarity of the travel conditions. That is, for example, even when the travel conditions of the combined routes are within a predetermined range, when the differences in the travel conditions of the combined routes are relatively large, a determination is made that the accuracy of the power consumption information when driving along the obtained composite route is relatively low, and the priority P is set to be low. On the other hand, when the differences in the travel conditions of the combined routes are relatively small, a determination is made that the accuracy of the power consumption information when driving along the obtained composite route is relatively high, and the priority P is set to be high.

Then, when a plurality of similar composite routes (composite routes that have a travel start point within the departure point range R_{O} and a travel end point within the destination point range R_{D}) are detected as a result of searching for a similar composite route that is identical or similar to the planned route in the above-described step S404, the historical statistics processing unit 27 determines preferentially that, of the plurality of detected similar composite routes, those with higher priorities P are presentation routes. That is, in the present embodiment, a predetermined number of similar composite routes in descending order of priority P are determined to be presentation routes. Alternatively, the configuration may be such that, when selecting a presentation route, consideration is given as to whether or not the conditions are similar to current ones, in addition to priority P.

In the present embodiment, for example, if the travel conditions of the routes that configure a composite route are such that the date/time are the same and the time zones are relatively similar, the driving history that corresponds to such routes, while including rest or charging stops, can be determined to configure a single trip; therefore, such a composite route can be set with the highest priority P. Examples of such cases include a method for determining whether or not the time difference of the combined routes (the difference between the time at travel end time and the time of the subsequent travel start time) is within a predetermined time (for example, within one hour) and a method for referring to the charging time information, which is included in the second piece of driving history information.

According to the second embodiment, achieving the following effects, in addition to the effects of the first embodiment, is possible. That is, according to the second embodiment, when a plurality of routes traveled by the same vehicle are combined to generate a composite route, the travel conditions of the routes to be combined are required to be within a predetermined range in addition to having a travel start point within a composite point range R_{S}, which is a circular range having a radius r_{S} from the travel end point; as a result, appropriately obtaining a similar composite route that is identical or similar to the planned route that includes more accurate information (includes more accurate power consumption information) is possible. Accordingly, providing power consumption information and charging hub information that are more in accordance with the actual environment is possible.

In addition, according to the second embodiment, since the presentation route that is actually presented to the driver is selected based on the priority P, which represents the similarity of the travel conditions, when a plurality of similar composite routes having travel start points within the departure point range R_{O} and travel end points within the destination point range R_{D} are detected, providing more accurate power consumption information and charging hub information is thereby possible.

A third embodiment of the present invention will be explained next. In the third embodiment, as described below, in a vehicle information provision system S illustrated in FIG. 1, besides being different from the first embodiment in the point that a plurality of routes on which a plurality of different vehicles have traveled are also targeted for combination and in addition to the plurality of routes traveled by the same vehicle, when generating a composite route, this embodiment comprises the same configuration and exerts the same effects as the first embodiment described above.

That is, in the present embodiment, upon generating a composite route, when there is a travel start point of a “route 6 of vehicle A₂,” which is a route of another vehicle A₂, within a composite point range R_{S}, which is a circular range having a radius r_{S} from the travel end point of “route 1 of vehicle A₁,” the driving history accumulation unit 26 combines the above and generates a composite route of “route 1 of vehicle A₁” and “route 6 of vehicle A₂,” as illustrated in part (A) of FIG. 1.

In this type of case as well, as illustrated in part (B) of FIG. 1, the driving history accumulation unit 26 may combine a “route 7 of vehicle A₃,” which is a route of yet another vehicle A₃, and generate a composite route that is generated by combining the routes of three vehicles A₁, A₂, and A₃.

Additionally, in the present embodiment, requiring that the travel conditions of the routes to be combined are within a predetermined range, in addition to having a travel start point within a composite point range R_{S}, which is a circular range having a radius r_{S} from the travel end point, is preferable when generating a composite route, in the same way as in the above-described second embodiment. In particular, when making a plurality of routes on which a plurality of different vehicles have traveled the targets of the combination, there is a tendency that the differences in the travel conditions will become likely great while the number of combinable routes relatively increases. For this reason, in the present embodiment, in consideration of these points, requiring that the travel conditions of the routes to be combined are within a predetermined range is preferable when generating a composite route. Composite routes with greatly differing travel conditions will thereby not be generated, and the accuracy of the obtained composite routes can be ensured.

In addition, in the present embodiment, the travel conditions of the routes used for combining are compared, and priority P is set for each composite route according to the degree of similarity of the travel conditions in the same way as in the above-described second embodiment. In addition to the above, when a plurality of similar composite routes (composite routes that have a travel start point within the departure point range R_{O} and a travel end point within the destination point range R_{D}) are detected as a result of searching for a similar composite route that is identical or similar to the planned route in the above-described step S404, a determination is preferentially made that, of the plurality of detected similar composite routes, those with higher priorities P are the presentation routes, in the same way as in the above-described second embodiment.

When setting the priority P of the composite route in the present embodiment, if the routes used for combining are routes from a single vehicle, the priority P is set to be higher than when the routes are those from a plurality of different vehicles. In particular, the driving trends will be nearly identical if the composite route is one that combines the routes from the same vehicle; therefore, a determination can be made that the information from the same vehicle will include more accurate information (include more accurate power consumption information), when compared to that which combines the routes from a plurality of different vehicles. Accordingly, in the present embodiment, the priority P is set to be high in such cases.

According to the third embodiment, achieving the following effects, in addition to the effects of the first embodiment and the second embodiment, is possible. That is, according to the third embodiment, since a plurality of routes traveled by a plurality of different vehicles are made to be the targets of the combination, in addition to the plurality of routes traveled by the same vehicle when generating a composite route, generating a relatively larger quantity of composite route data is possible. Additionally, since these composite routes that are generated relatively more are made to be targets of the search, determining more appropriate presentation routes is possible. Accordingly, providing power consumption information and charging hub information that are more in accordance with the actual environment is possible.

Embodiments of the present invention were described above, but these embodiments have been described in order to facilitate an understanding of the present invention and are not described in order to limit the present invention. Therefore, the elements disclosed in the embodiments above are intended to include all design modifications and equivalents thereto that lie within the technical range of the present invention.

For example, in the embodiment described above, employing a configuration in which the extent of the departure point range R_{O} and the destination point range R_{D} are changed according to the distance between the departure point P_{O} and the destination point P_{D} (they increase as the distance increases) or in which the extent of the departure point range R_{O} and the destination point range R_{D} are changed according to the time required to travel from the departure point P_{O} to the destination point P_{D} (the travel time) (they increase as the required time increases) is possible.

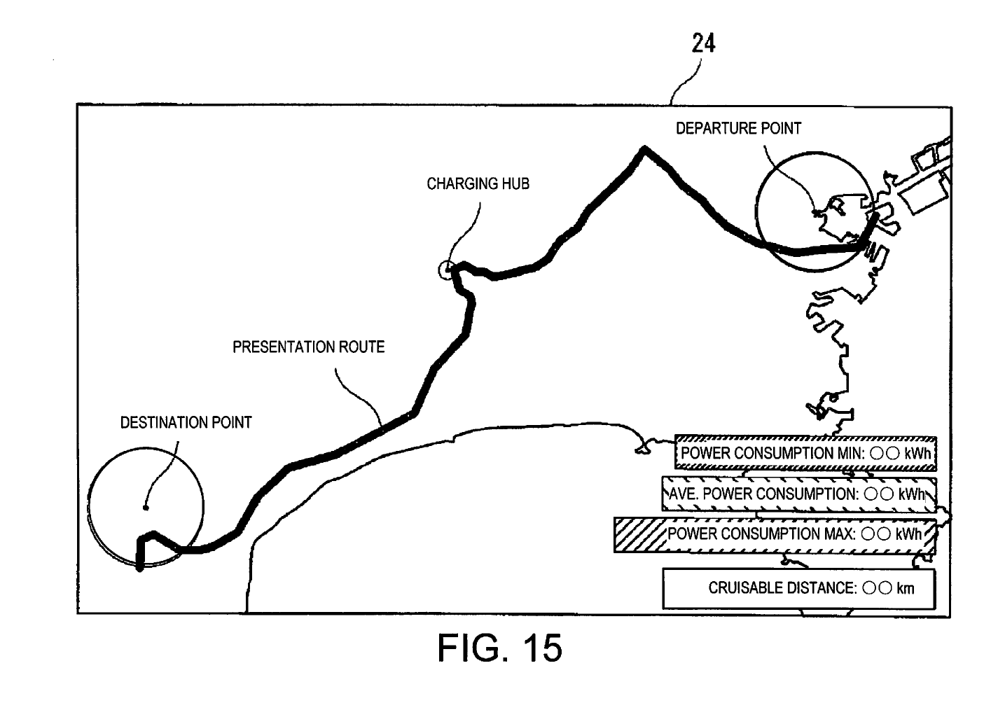

Additionally, in the above-described embodiment, the historical statistics processing unit 27 may be configured to refer to the first piece of driving history information that is accumulated by the driving history accumulation unit 26 and to determine the power consumption when driving along the presentation route (the similar route, the similar composite route) for each driver. In this case, the historical statistics processing unit 27 transmits (provides) to the source terminal device 2 information regarding the maximum power consumption, the minimum power consumption, and the average power consumption from the determined power consumption for each driver, along with information regarding the presentation route and the charging hubs. The source terminal device 2 thereby displays on the display screen the maximum power consumption (power consumption MAX), the minimum power consumption (power consumption MIN), and the average power consumption (average power consumption) in addition to the presentation route and the charging hubs, based on the received information, as illustrated in FIG. 15. In particular, according to this type of configuration, the power consumption when driving along the presentation route is calculated for each driver, and the maximum power consumption, the minimum power consumption, and the average power consumption of the calculated power consumption are provided. Accordingly, the user can obtain the degree of variation in the power consumption for each driver.

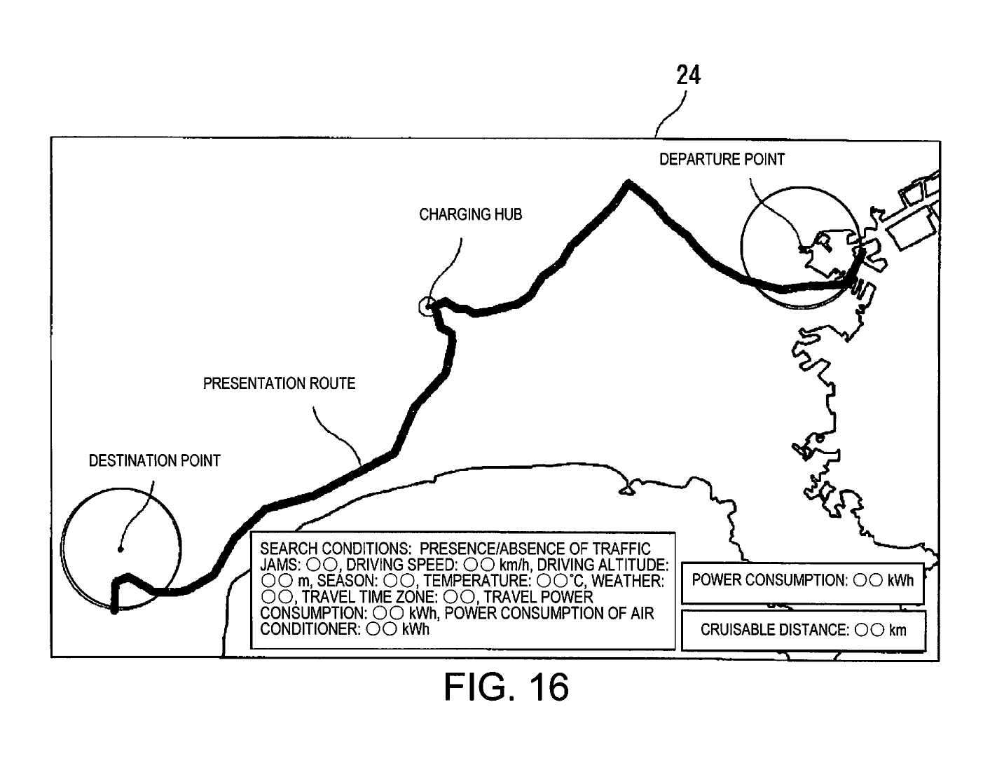

Additionally, in the embodiment described above, an example was explained in which the display unit 24 displays the power consumption and the charging hubs along with the presentation route (the similar route, the similar composite route), but another configuration may also be used. For example, the display unit 24 may be configured to display information regarding the presence/absence of traffic jams, the driving speed, the driving altitude, the season, the temperature, the weather, the travel time zone, the travel power consumption, and the power consumption by the air conditioner, which are included in the first piece of driving history information and the second piece of driving history information used for the extraction of the power consumption and charging hubs. Specifically, the terminal device 2 receives an input of at least the presence/absence of traffic jams, the driving speed, the driving altitude, the season, the temperature, the weather, the travel time zone, the travel power consumption, or the power consumption by the air conditioner (hereinafter also referred to as the state quantity for search). Next, the terminal device 2 transmits the received information regarding the state quantity for search to the vehicle information providing device 3. Subsequently, when information that is transmitted by the terminal device 2 is received, the vehicle information providing device 3 (the historical statistics processing unit 27) acquires the search condition state quantity from the received information. The historical statistics processing unit 27 then determines the power that has been consumed when driving along the selected presentation route, as well as the charging hubs that will be traversed when driving along the presentation route, by referencing the driving history information conforming to the acquired search condition, from among the driving history information that is accumulated by the driving history accumulation unit 26. Then, the historical statistics processing unit 27 transmits (provides) the acquired search condition information to the source terminal device 2, along with information regarding the presentation route (the similar route, the similar composite route), the power consumption, and the charging hubs. The source terminal device 2 thereby displays on the display screen the search conditions used for determining the power consumption and charging hubs, in addition to the presentation route, the power consumption, and the charging hubs, based on the received information, as illustrated in FIG. 16. According to this kind of configuration, the search conditions used for determining the power consumption and charging hubs are provided along with the presentation route, the power consumption, and the charging hubs. Accordingly, the driver can obtain the search conditions used for determining the power consumption and charging hubs.

In the embodiment described above, an example of a configuration was explained in which similar composite routes are searched for within the composite routes, regardless of whether or not a similar route was detected; however, the configuration may be such that similar composite routes are only searched for when similar routes are not detected; as a result of the search, if a similar composite route having a travel start point within the departure point range R_{O} and having a travel end point within the destination point range R_{D} is detected, this is determined to be the presentation route. In particular, in this case, a similar composite route is only searched for when searching for a similar composite route is necessary; as a result, reducing the calculation load is possible.

Additionally, upon generating a composite route, when the travel end point of an arbitrary route is located in an area corresponding to a large-scale facility of a predetermined scale or greater (for example, a large store, an amusement park, etc.), or when located in a chargeable facility area equipped with a public charging facility, these areas, that is, the large-scale facility areas and the chargeable facility areas, may be set as the composite point ranges RS. In particular, these types of large-scale facilities and chargeable facilities are utilized by a great number of vehicles; therefore, by setting the ranges of such facilities as composite point ranges RS, generating a relatively large number of composite routes with relatively similar travel conditions becomes possible. Information regarding large-scale facility areas and chargeable facility areas can be used by, for example, storing this information in the map information storage unit 25 in advance.

Additionally, in the embodiment described above, the configuration may be such that, when setting the priority P, the priority P is set according to the distance between the travel end point and the travel start point at the combined point of the combined routes, in addition to the degree of similarity of the travel conditions or instead of the degree of similarity of the travel conditions. That is, when the distance between the travel end point and the travel start point at the combined point of the combined routes is relatively close, the priority P is set to be high; when this distance is relatively far, the priority P is set to be low. In particular, when the distance between the travel end point and the travel start point at the combined point of the combined routes is relatively close, the error in the power consumption according to this distance gap will become relatively small; as a result, the priority P of such composite routes is set to be high; when the distance is relatively far, the error in the power consumption according to this distance gap will become relatively large, so that the priority P of such composite routes is set to be low; as a result, appropriately providing that which includes more accurate information (that which includes more accurate power consumption information) is thereby possible. In the present embodiment, the configuration may also be such that, when setting the priority P, the priority P is set according to the time required (priority P is set higher, the shorter the required time) to arrive at the travel end point from the travel start point (travel time), in addition to the degree of similarity of the travel conditions or instead of the degree of similarity of the travel conditions.

Furthermore, in the embodiment described above, when setting the priority P, the routes including specific points, such as the location of the home of the driver of vehicle A, may be detected, and the priority P may be set to be relatively low regarding the composite routes obtained by using routes that include such specific points. In particular, since there is a tendency for idling at the location of a home or the power consumption tends to become higher when traveling towards the location of a home, when the location of a home comprises the travel start point or the travel end point, there tends to be more of those points including less accurate information (those including the less accurate power consumption information). Accordingly, in such a case, by setting the priority P to be relatively low, appropriately providing more accurate information (that which includes more accurate power consumption information) is possible. As a method for determining whether or not a route includes specific points such as the location of a home, a determination can be made by detecting certain points that have a stay frequency or a stay time that is equal to or greater than a predetermined threshold value (points having relatively high stay frequencies or points having relatively high stay times (for example, a stay time that is 12 hours or more)) by referencing the travel start point information, the travel end point information, the date/time information at the travel start time, and the date/time information at the travel end time, etc., which are included in the first piece of driving history information.

In the above-described embodiment, the driving history accumulation unit 26 of the vehicle information providing device 3 corresponds to the history information accumulation unit and the composite route generation unit of the present invention; the historical statistics processing unit 27 of the vehicle information providing device 3 corresponds to the planned route acquisition unit, the first presentation route determination unit, the first presentation information determination unit, the second presentation route determination unit, the second presentation information determination unit, and the presentation information provision unit of the present invention.

1. A vehicle information providing device comprising:
a history information accumulation unit that sequentially acquires at least one of driving location information, power consumption information and charging location information from vehicle-mounted devices installed on a plurality of vehicles that each have an electric motor as a drive source and accumulates this information as the driving history information;
a composite route generation unit that generates a composite route by combining a plurality of routes that are driven by the same vehicle by referencing the driving history information that is accumulated by the history information accumulation unit; and
a presentation information provision unit that provides information regarding a composite route generated by the composite route generation unit,
the composite route generation unit extracting from information regarding a travel start point and a travel end point of each route included in the driving history information when generating the composite route and combines routes having travel end points and travel start points within a predetermined spatial range.

2. The vehicle information providing device as recited in claim 1, further comprising:
a planned route acquisition unit that acquires a planned route from a departure point to a destination point;
a first presentation route determination unit that searches for a composite route that is identical or similar to the planned route that is acquired by the planned route acquisition unit from the composite routes that are generated by the composite route generation unit and determines the searched composite route to be a first presentation route; and
a first presentation information determination unit that determines at least one of the power that is consumed when driving along the first presentation route and charging hubs that will be traversed when driving along the first presentation route by referencing the driving history information that is accumulated in the history information accumulation unit;
the presentation information provision unit providing information regarding determination results of the first presentation route determination unit and determination results of the first presentation information determination unit as composite route information.

3. The vehicle information providing device as recited in claim 2, further comprising:
a second presentation route determination unit that determines a route that is identical or similar to the planned route that is acquired by the planned route acquisition unit as a second presentation route, within single routes that are routes traveled by one vehicle at once, by referencing the driving history information that is accumulated by the history information accumulation unit; and
a second presentation information determination unit that determines at least one of the power that is consumed when driving along the second presentation route and the charging hubs that will be traversed when driving along the second presentation route by referencing the driving history information that is accumulated in the history information accumulation unit;
the presentation information provision unit providing information regarding determination results of the second presentation route determination unit and determination results of the second presentation information determination unit, along with information regarding the determination results of the first presentation route determination unit and the determination results of the first presentation information determination unit.

4. The vehicle information providing device as recited in claim 2, further comprising:
a second presentation route determination unit that determines a route that is identical or similar to the planned route that is acquired by the planned route acquisition unit as a second presentation route, within single routes that are routes traveled by one vehicle at once, by referencing the driving history information that is accumulated by the history information accumulation unit; and
a second presentation information determination unit that determines at least one of the power that is consumed when driving along the second presentation route and the charging hubs that will be traversed when driving along the second presentation route by referencing the driving history information that is accumulated in the history information accumulation unit;
the presentation information provision unit providing information regarding the determination results of the second presentation route determination unit and the determination results of the second presentation information determination unit if a second presentation route can be determined by the second presentation information determination unit and provides information regarding the determination results of the first presentation route determination unit and the determination results of the first presentation information determination unit if the second presentation route cannot be determined by the second presentation information determination unit.

5. The vehicle information providing device as recited in claim 1, wherein
the composite route generation unit refers to information regarding a travel start point and a travel end point of each route included in the driving history information when generating the composite route and combines the routes having travel end points and travel start points within a predetermined distance range.

6. The vehicle information providing device as recited in claim 1, wherein
the composite route generation unit refers to information regarding a travel start point and a travel end point for each route included in the driving history information when generating the composite route, performs an indexing operation in an area in which a travel start point and a travel end point of each route is divided into predetermined ranges, and combines the routes for which the travel end points and the travel start points belong to the same index.

7. The vehicle information providing device as recited in claim 1, wherein
the composite route generation unit records at least one of the information regarding large-scale facilities of a predetermined scale or greater and information regarding chargeable facilities equipped with public charging facilities, and
the composite route generation unit refers to information regarding a travel start point and a travel end point for each route included in the driving history information when generating the composite route and combines the routes for which the travel start point and the travel end point are located in at least one of the same large-scale facility and the same chargeable facility.

8. The vehicle information providing device as recited in claim 1, wherein
the composite route generation unit, when combining a plurality of routes, combines routes having travel end points and travel start points within a predetermined spatial range and for which the travel conditions are within a predetermined range.

9. The vehicle information providing device as recited in claim 8, wherein
the travel conditions include at least one of the following conditions: the travel time zone, the driving speed, the driving altitude, the day of week, the season, the temperature, the weather, and the air conditioner power consumption.

10. The vehicle information providing device as recited in claim 1, wherein
the composite route generation unit sets a priority to be higher as the distance between a travel start point and a travel end point at a combined point of a plurality of routes used for generating the composite route become closer, and
the first presentation route determination unit selects the first presentation route, in consideration of the priority of the composite route, when determining the first presentation route from the composite routes.

11. The vehicle information providing device as recited in claim 8, wherein
the composite route generation unit sets a priority to be higher as the travel conditions of a plurality of routes used for generating the composite route become more similar, and
the first presentation route determination unit selects the first presentation route, in consideration of the priority of the composite route, when determining the first presentation route from the composite routes.

12. The vehicle information providing device as recited in claim 10, wherein
the composite route generation unit sets the priority of the composite route to be higher when the composite routes includes a plurality of routes traveled by the same vehicle, as compared to when these includes a plurality of routes traveled by a plurality of vehicles.

13. The vehicle information providing device as recited in claim 1, wherein
the driving history information accumulated in the history information accumulation unit is referenced, a point in which a stay frequency or a stay time is equal to or greater than a predetermined threshold value is searched for each vehicle, and the point is detected as a specific point, and
the composite route generation unit sets the priority of the composite route to be lower when the specific points of corresponding vehicles are included in the travel start points and the travel end points of a plurality of routes used for generating the composite route, as compared to when the specific points are not included.
